(19) United States
(12) Patent Application Publication
(10) Pub. No.: US 2024/0352189 A1
(43) Pub. Date: Oct. 24, 2024

(54) Method for Preparing a Polysiloxane-Polycarbonate Block Copolymer Using at Least One Special Condensation Reactor

(71) Applicant: Covestro Deutschland AG, Leverkusen (DE)

(72) Inventors: Ulrich Liesenfelder, Bergisch Gladbach (DE); Johan Vanden Eynde, Zwijnaarde (BE); Marc Buts, Duffel (BE); Alexander Meyer, Düsseldorf (DE); Paul Van Dorst, Merksplas (BE); Max Spapens, Bergen op Zoom (NL); Marcus De Wolf, Deurne (BE); Roland Engberg, Düsseldorf (DE); Gregor Karrenberg, Wuppertal (DE)

(21) Appl. No.: 18/292,663

(22) PCT Filed: Jul. 19, 2022
(86) PCT No.: PCT/EP2022/070219

§ 371 Date: Jan. 26, 2024

(30) Foreign Application Priority Data
Jul. 27, 2021 (EP) 21187920.0

(51) Int. Cl. C08G 64/18; C08G 64/20; C08G 77/00; C08G 77/16; C08G 77/448

(52) U.S. Cl. CPC C08G 64/186; C08G 64/205; C08G 77/16; C08G 77/448; C08G 77/80

(57) ABSTRACT

A multi-stage process for continuous production of a polysiloxane-polycarbonate block copolymer by polycondensation is disclosed where in a first stage an oligocarbonate and a hydroxyaryl-terminated polysiloxane are provided and in a second stage at least one special condensation reactor is used. A certain amount of a particular co-catalyst is added and this co-catalyst is added upstream of the first special condensation reactor. The polysiloxane-polycarbonate block copolymer produced by the process according to the invention has a high proportion of small polysiloxane domains and features good mechanical properties, in particular tough fracture behaviour in the notched impact test according to ISO 7391/ISO 180A, good processability, for example in injection moulding or in extrusion, and good flowability.

### CROSS-REFERENCE TO RELATED APPLICATIONS

This application is the United States national phase of International Application No. PCT/EP2022/070219 filed Jul. 19, 2022, and claims priority to European Patent Application No. 21187920.0 filed Jul. 27, 2021, the disclosures of which are hereby incorporated by reference in their entireties.

### BACKGROUND

### Technical Field

The present invention relates to a multi-stage process for continuous production of a polysiloxane-polycarbonate block copolymer by polycondensation, wherein the process is characterized in that in a first stage an oligocarbonate and a hydroxyaryl-terminated polysiloxane are provided and in a second stage at least one special condensation reactor is used, preferably in a second stage precisely one special condensation reactor is used or precisely two serially arranged special condensation reactors are used. The process is further characterized in that a certain amount of a particular co-catalyst (as described further below) is added and this co-catalyst is added upstream of the first special condensation reactor. The process according to the invention preferably comprises producing the oligocarbonate using a horizontal reactor in the first stage, said oligocarbonate being reacted with a hydroxyaryl-terminated polysiloxane to afford a polysiloxane-polycarbonate block copolymer—also known as SiCoPC—in the second stage. The process is further characterized in that in the reaction of the oligocarbonate with the hydroxyaryl-terminated polysiloxane using at least one special condensation reactor certain process parameters are observed. The polysiloxane-polycarbonate block copolymer produced by the process according to the invention has a high proportion of small polysiloxane domains and features good mechanical properties, in particular tough fracture behaviour in the notched impact test according to ISO 7391/ISO 180A, good processability, for example in injection moulding or in extrusion, and good flowability.

The particular co-catalyst is selected here from one or more co-catalysts based on alkali metals or alkaline earth metals.

In the context of the present invention a high proportion of small polysiloxane domains is provided when the numerical proportion of polysiloxane domains larger than or equal to 12 nm and smaller than 200 nm is more than 99.0%, preferably more than 99.2%, particularly preferably more than 99.5% and very particularly preferably more than 99.9%, in each case based on the total number of polysiloxane domains larger than or equal to 12 nm.

To determine the size of the polysiloxane domains polymer samples are cut at low temperature and subjected to examination by scanning electron microscopy as more particularly described below. In the context of the present invention the diameter of a polysiloxane domain is to be understood here as meaning the diameter of the equivalent projection area of a circle of the cross section of the polysiloxane domain visible in the cut.

It is known that polysiloxane-polycarbonate block copolymers exhibit good properties in terms of low-temperature impact strength/low-temperature notched impact strength, chemicals resistance and exterior weathering resistance as well as ageing characteristics and fire resistance. They are superior to conventional polycarbonates, i.e. standard polycarbonates, in terms of these properties. In the context of the present invention a conventional polycarbonate or standard polycarbonate is understood as meaning a homopolycarbonate based on bisphenol-A as the diphenol monomer unit.

In the context of the present invention the relative solution viscosity is determined with an Ubbelohde viscometer in each case in dichloromethane at a concentration of 5 g/l at 25° C.

### Description of Related Art

According to the prior art polysiloxane-polycarbonate block copolymers are produced industrially via the so-called phase interface process with phosgene starting from diphenol monomers and polydiorganosiloxanes. The production of polysiloxane-polycarbonate block copolymers starting from diphenol monomers and polydiorganosiloxanes via the so-called melt transesterification process using diphenyl carbonate is also known from the prior art. However, this melt transesterification process has not hitherto been implemented on an industrial scale for producing polysiloxane-polycarbonate block copolymers.

In the case of the phase interface process the production of polysiloxane-polycarbonate block copolymers according to the prior art has the disadvantage that starting materials with special handling requirements such as phosgene are required. Furthermore, if an industrial plant configured for producing standard polycarbonate is used for producing polysiloxane-polycarbonate block copolymers in the melt transesterification process the residence times of the reaction mixtures for producing the polysiloxane-polycarbonate block copolymers at high temperatures in the reactors are very lengthy. This severely increases the thermal stress on the polysiloxane-polycarbonate block copolymers which has an adverse effect on the properties of the polysiloxane polycarbonate block copolymers.

The production of polysiloxane-polycarbonate block copolymers by the melt transesterification process is also described in EP 0 864 599 B1 or in EP 0 770 636 A2. The reaction times disclosed therein are not economically useful for a large industrial scale process, however. These documents do not contain any practical teaching of how to possibly shorten the reaction times and thus also the residence times.

EP 0 770 636 A2 also discloses that small polysiloxane domain sizes down to 15 nm are achievable but the polysiloxane domain size apparent only from the figures is not useful for present-day demands. It is moreover not disclosed how a high proportion of small polysiloxane domains is obtainable.

Large polysiloxane domains, i.e. polysiloxane domains of 200 nm or larger, in a polysiloxane-polycarbonate block copolymer, especially when present in large numbers, have an adverse effect on the aesthetic appearance and/or the mechanical properties of mouldings produced from a polysiloxane-polycarbonate block copolymer. Large polysiloxane domains can lead to demixing of the polysiloxane phase from the polycarbonate phase in the polysiloxane-polycarbonate block copolymer which manifests in an inhomogeneous surface structure of the polysiloxane-polycarbonate block copolymer and can result in flow lines and striping and in undesired optical interferences in an injection-moulded shaped body made of polysiloxane-polycarbonate block copolymer. The aesthetic appearance of such a shaped body is inadequate and such a shaped body is no longer uniformly colorable and is thus unsuitable for many commercial uses. Since large polysiloxane domains are shear-sensitive and can cause delamination in a shaped body produced from such a polysiloxane-polycarbonate block copolymer by injection moulding, such polysiloxane-polycarbonate block copolymers are moreover difficult to process in injection moulding with the result that often only very low injection speeds are employable which is undesirable since it prolongs the cycle time.

Furthermore, neither EP 864 599 B1 nor EP 0 770 636 A2 give any indication of how to possibly adjust the flowability of the obtained polysiloxane-polycarbonate block copolymers.

EP 0 726 285 A2 describes a two-stage process for production of polycarbonate employing alkali metal- or alkaline earth metal-based co-catalysts. The present application further describes the arrangement of reactors in the individual reaction stages. It is thus especially noted that the last reaction stage requires the use of a high-viscosity reactor, in particular a twin-screw extruder (referred to there inter alia ZSK). However, it has surprisingly been found that such an arrangement is disadvantageous for the product properties/does not meet the requirements of economic production. It has been found that it is not possible to effect scaleup of such a process to an industrial scale process. It is thus not possible, as described above, to utilize the melt transesterification process for an industrial process.

In addition, EP 0 726 285 A2 does not disclose how to possibly produce polysiloxane-polycarbonate block copolymers having a large proportion of small polysiloxane domains.

A person skilled in the art is aware of what is to be understood by a polysiloxane domain and may be found for example both in the publication “Structure to Property Relationship in Polycarbonate/Polydimethylsiloxane Copolymers”, by Matthew R. Pixton, published in “Associacao Brasileira de Polimeros, Sao Paulo, SP (Brazil); [vp.]; 2005; 2 p; 8. Brazilian congress on polymers; 8. congresso brasileiro de polimeros; Aguas de Lindoia, SP (Brazil); 6-10 Nov. 2005” and in the publication “Structure to Property Relationship in Polycarbonate/Polydimethylsiloxane Copolymers”, by Matthew R. Pixton, published in “ANTEC 2006, Annual Technical Conference, Charlotte, North Carolina, 7-11 May 2006, Conference Proceedings, pages 2655-2659”.

It is known in principle how to possibly reduce the proportion of large polysiloxane domains in the polysiloxane-polycarbonate block copolymer. The addition of compatibilizers is described for example in EP 3719077 A1/WO 2020201178 A1. However the compatibilizers described therein are very costly, which markedly increases the raw material costs of the polysiloxane-polycarbonate block copolymer. Other compatibilizers are also disadvantageous since they are very costly or not employable on account of the high temperatures in the melt transesterification process since they undergo decomposition or result in a product having inadequate melt stability.

### SUMMARY

Starting from the recited prior art it was therefore the object to overcome at least one disadvantage of the prior art. It was especially the object of the present invention to provide a process for producing a polysiloxane-polycarbonate block copolymer which eschews starting materials with special handling requirements such as phosgene, which can be run solventlessly and which is capable of scaleup to an industrial scale and capable of economic operation. It was further the object to develop a melt transesterification process which is scalable and which makes it possible to produce a polysiloxane-polycarbonate block copolymer having a high proportion of small polysiloxane domains in conjunction with good flowability. Good flowability is advantageous since during further processing of a polysiloxane-polycarbonate block copolymer in injection moulding it allows the production of parts having complex geometry and thin wall thicknesses. It was further the object to configure the process such that the process allows short residence times and is cost-effective. In the present context residence time means the time required to produce the desired polysiloxane-polycarbonate block copolymer with the desired relative solution viscosity by incorporation of the polysiloxane component; in the processes according to the invention described below the residence time coincides with the reaction time.

The process shall be run on a continuous basis. Furthermore, it was a further object to be able to eschew costly compatibilizers.

It was especially the object to provide a process which is capable of scaleup, i.e. which starting from a laboratory process capable of producing in a single laboratory plant on a discontinuous basis for example 1 to 200 g, at most 1 kg, of polysiloxane-polycarbonate block copolymer per batch, is transferrable via a pilot-scale process capable of producing in a single pilot plant for example on a continuous basis 1 to 100 kg of polysiloxane-polycarbonate block copolymer per hour, to an industrial scale where on a continuous basis from 100 kg to more than 500 kg/h of polysiloxane-polycarbonate block copolymer are producible on one production line, preferably more than 1000 kg/h of polysiloxane-polycarbonate block copolymer.

It shall be the case here that in the polysiloxane-polycarbonate block copolymer the numerical proportion of polysiloxane domains larger than or equal to 12 nm and smaller than 200 nm is more than 99.0%, preferably more than 99.2%, particularly preferably more than 99.5% and very particularly preferably more than 99.9%, in each case based on the total number of polysiloxane domains larger than or equal to 12 nm.

At the same time the flowability shall remain high. However, the flowability shall not exceed a value where it leads to poorer mechanical properties of a moulding produced—in particular by injection moulding—from the polysiloxane-polycarbonate block copolymer produced by the process according to the invention. Relative solution viscosity may be regarded as a measure for flowability. Thus the relative solution viscosity of a polysiloxane-polycarbonate block copolymer produced by the process according to the invention having a polysiloxane content of 2% to 15% by weight, preferably of 3% to 10% by weight, particularly preferably having a polysiloxane content of 4% to 8% by weight, shall preferably be from 1.24 to 1.38, preferably from 1.26 to 1.36, particularly preferably from 1.27 to 1.35. A polysiloxane-polycarbonate block copolymer produced according to the invention is readily processable, for example by injection moulding or extrusion, in this range of relative solution viscosity.

Very particularly preferably the relative solution viscosity of a polysiloxane-polycarbonate block copolymer produced by the process according to the invention having a polysiloxane content of 4.5% to 5.5% by weight shall be from 1.24 to 1.34, preferably from 1.26 to 1.33, particularly preferably from 1.27 to 1.32.

The especially preferred range is selected here such that this polysiloxane content in conjunction with the specified viscosity makes it possible to achieve not only good mechanical properties but also good processability. The solution viscosity which is elevated especially at higher polysiloxane concentrations can have the result that processability is no longer optimal. However, it is possible through admixture of conventional polycarbonate having a lower viscosity to establish a polysiloxane content which corresponds to the very particularly preferred range. This material then once again features the good mechanical properties in conjunction with good flowability. A person skilled in the art is familiar with the mixing/compounding of such components, in particular also which viscosity of conventional polycarbonate needs to be employed to achieve the corresponding viscosities.

Here too, it shall be the case that in the polysiloxane-polycarbonate block copolymer the numerical proportion of polysiloxane domains larger than or equal to 12 nm and smaller than 200 nm is more than 99.0%, preferably more than 99.2%, particularly preferably more than 99.5% and very particularly preferably more than 99.9%, in each case based on the total number of polysiloxane domains larger than or equal to 12 nm.

A polysiloxane-polycarbonate block copolymer produced according to the invention is very especially readily processable, for example by injection moulding or extrusion, in the very particularly preferred range of relative solution viscosity.

It is further particularly preferable when a polysiloxane-polycarbonate block copolymer produced by the process according to the invention exhibits tough fracture behaviour down to −60° C. in the notched impact test according to ISO 7391/ISO 180A. This is the case especially when the polysiloxane-polycarbonate block copolymer produced by the process according to the invention has a polysiloxane content of 4.5% to 5.5% by weight. However, it is once again noted here that the same good mechanical properties are achievable at high polysiloxane contents in the polysiloxane-polycarbonate block copolymer through compounding of these polysiloxane-polycarbonate block copolymers with conventional polycarbonate according to the prior art.

### BRIEF DESCRIPTION OF THE DRAWINGS

FIG. 1 shows an experimental setup for certain of the Examples.

FIG. 2 shows a scheme for producing a polysiloxane-polycarbonate block copolymer.

FIG. 3 shows a scheme for producing a polysiloxane-polycarbonate block copolymer.

FIG. 4 shows an experimental setup for certain of the Examples.

### DESCRIPTION

These objects are surprisingly achieved by a process for producing a polysiloxane-polycarbonate block copolymer from an oligocarbonate and a hydroxyaryl-terminated polysiloxane, wherein this process is characterized in that it is a multi-stage process in which a sequence of different reactors is employed. The objects are surprisingly especially achieved by a process wherein in a first stage an oligocarbonate and a hydroxyaryl-terminated polysiloxane are provided and in a second stage at least one special condensation reactor is employed, preferably in a second stage precisely one special condensation reactor is employed or precisely two special condensation reactors are employed, wherein a certain amount of a particular co-catalyst is added, wherein this certain amount of this particular co-catalyst is added upstream of the first special condensation reactor. The particular co-catalyst is selected here from one or more co-catalysts based on alkali metals or alkaline earth metals. Further, particular process conditions are also to be observed. In the process according to the invention in the first stage the oligocarbonate is preferably produced using a horizontal reactor.

In the context of the present invention a horizontal reactor, disclosed for example in DE4447422A1 or EP0460466A1, as preferably employed in a first stage of the process according to the invention is characterized in that it comprises a reaction space having at least one shaft, wherein the length of the reaction space is greater than the largest cross sectional diameter of the reaction space. The length and the cross sectional diameter of the reaction space are spatial extents that are perpendicular to one another. Here, the longitudinal axis of the reaction space is in the horizontal with a deviation of at most +/−0.2° as an incline from the inlet of the reaction chamber to the outlet of the reaction chamber. The at least one shaft that the reaction chamber comprises is preferably oriented parallel to the longitudinal axis of the reaction chamber. The reaction space of a horizontal reactor is preferably cylindrical provided it comprises only one shaft; if the reaction space of a horizontal reactor comprises a plurality of shafts, in particular shafts that are both mutually parallel and parallel to the longitudinal axis of the reaction space, it is preferably constructed from mutually parallel interpenetrating cylinder housings—as disclosed in EP0460466A1 for example.

In the context of the present invention it is noted for clarity that a single-, twin- or multi-screw extruder is not considered as a horizontal reactor.

A special condensation reactor in the context of the present invention is characterized in that
it comprises a reaction chamber having a shaft, wherein the length of the reaction chamber in the direction of the rotational axis is greater than the largest cross sectional diameter of the reaction chamber. The length and the cross sectional diameter of the reaction chamber are spatial extents that are perpendicular to one another. Here, the longitudinal axis of the reaction chamber is in the vertical with a deviation of at most +/−0.1° as an incline relative to the vertical. The shaft that the reaction chamber comprises is attached parallel to the longitudinal axis of the reaction chamber. Force-fittingly secured to the circumference of the shaft or configured as a constituent of the shaft is at least one spreader, in the form for example of a wiper or a wiper blade element or a spiral or a screw, which upon rotation of the shaft
(1) rotates with said shaft
and which
(2) is oriented from the shaft towards the reaction chamber inner surface area
and whose
(3) outer edge oriented towards the reaction chamber inner surface area wipes the reaction chamber inner surface area during a revolution of the shaft without touching the reaction chamber inner surface area; there is accordingly a gap between the outer edge of the spreader, oriented towards the reaction chamber inner surface area, and the reaction chamber inner surface area. This wiping is preferably performed such that the layer thickness of a reaction mixture spread out on the reaction chamber inner surface area is at least 0.5 mm and at most 20 mm, is particularly preferably at least 1 mm and at most 10 mm, particularly preferably at least 1.5 mm and at most 6 mm. It is preferable when a special condensation reactor comprises a multiplicity of spreaders, for example two, three, four or else substantially more, for example twenty and more.

In the context of the present invention “reaction chamber inner surface area” is understood as meaning the surface area of the special condensation reactor to which the reaction mixture is applied. The respective reaction chamber inner surface area of a thin-film evaporator is a feature which is unambiguously specified for the individual thin-film evaporator by the manufacturer as a consequence of construction and is determinable by simple measurement.

A special condensation reactor may be traversed by a reaction mixture both from top to bottom and from bottom to top, preferably from top to bottom. If a special condensation reactor is traversed from top to bottom by a reaction mixture this is at least partially gravity-driven; if a special condensation reactor is traversed from bottom to top by a reaction mixture this requires the presence of an apparatus, for example a screw or a spiral which maintains this flow counter to the gravitational force.

A special condensation reactor may be configured as a thin-film evaporator or as an extruder for example.

A special condensation reactor in the context of the present invention makes it possible in proper operation to achieve an input of reaction mixture into this special condensation reactor of 20 kg/m²h to 100 kg/m²h based on the reaction chamber inner surface area. This input of reaction mixture into a special condensation reactor based on the reaction chamber inner surface area is hereinbelow referred to as the “application rate”. When using more than one special condensation reactor the inner surface area used for calculating the application rate is the sum of the inner surface areas of the reaction chambers of the serially arranged special condensation reactors, wherein the value of 20 kg/m²h to 100 kg/m²h for the application rate of the reaction chamber inner surface area with reaction mixture is retained; this applies independently of whether only one special condensation reactor is used or whether a plurality of serially arranged special condensation reactors are used.

It is preferable when the special condensation reactor is a thin-film evaporator.

In the context of the present invention a thin-film evaporator is a vertically arranged apparatus which comprises an axially extending rotationally symmetrical—preferably cylindrical—reaction chamber and which is supplied at its upper end with a reaction mixture composed of a polymer melt and a liquid polysiloxane in the form of a melt dispersion, said mixture being discharged from the apparatus at its lower end in the form of a further reacted reaction mixture, and which is fitted with a rotor, i.e. a rotating shaft, having at least two wiper blade elements, generally three, four or more wiper blade elements, secured to it at the circumference. Here, each wiper blade element has an outer edge, wherein the outer edge of a wiper blade element extends axially and is directed at the inner surface area of the axially extending rotationally symmetrical reaction chamber and spreads out the reaction mixture on the inner circumference of the axially extending rotationally symmetrical reaction chamber and thus always ensures surface renewal of the reaction mixture. Here, the inner surface area of the reaction chamber has the same geometric shape as the reaction chamber, i.e. a cylindrical reaction chamber also has a cylindrical inner surface area. Here, a wiper blade element may be arranged axially parallel or at a working angle to the longitudinal axis. Thin-film evaporators that are suitable in principle for performing the process according to the invention are disclosed for example in EP3318311A1, EP1792643A1, EP0356419A2, DE19535817A1, DE102012103749A1, DE2011493A1 or DD-226778B1 or in the publication [1] “Platzer (ed.): Polymerization Kinetics and Technology, Advances in Chemistry; American Chemical Society: Washington, DC, 1973, pages 51 to 67: Fritz Widmer: Behaviour of Viscous Polymers during Solvent Stripping or Reaction in an Agitated Thin Film; Swiss Federal Institute of Technology, Zurich, Switzerland”, wherein the thin-film evaporator disclosed in DE19535817A1, DD-226778B1 or in EP3318311A1 or the thin-film evaporator disclosed in [1], FIG. 7, page 58, and FIG. 9, page 60, is especially suitable for performing the process according to the invention. Furthermore, options for configuring thin-film evaporators are disclosed in the article “Scaleup of Agitated Thin-film Evaporators”, William B. Glover, reprinted from Chemical Engineering, April 2004.

The spreading out of the melt of the reaction mixture on the reaction chamber inner surface area of the thin-film evaporator is important since the polycondensation of the oligocarbonate and the polysiloxane to afford the polysiloxane-polycarbonate block copolymer requires effective removal of a hydroxyl compound—generally phenol—formed during the polycondensation by evaporation and thus requires constant surface renewal. Such tasks where a large surface area coupled with good surface renewal is to be produced normally employ reactors such as high-viscosity rotating-disc reactors, as disclosed for example in DE4447422A1 or in EP0460466A1, or other high-viscosity reactors, such as for example mesh basket reactors as disclosed in WO02085967A1 for example. However, such high-viscosity reactors have the disadvantage of long residence times, especially in the production of polysiloxane-polycarbonate block copolymers.

Long residence times make the process for producing polysiloxane-polycarbonate block copolymers inflexible. Thus, long residence times result in the generation of large amounts of transitional product, which is often not usable for further processing, when changing from one polysiloxane-polycarbonate block copolymer to be produced to another polysiloxane-polycarbonate block copolymer to be produced in a continuous process. Long residence times are also harmful to product quality, since thermal damage increases at high residence times.

As already set out further above EP 0 726 285 A2 describes the preferred use of twin-screw extruders (called there inter alia ZSK) in the last process section to ensure surface renewal. However, it was found that the combination of reactors described in EP 0 726 285 A2 is not optimal for product quality and that the process either cannot be scaled up to an industrial scale and/or the product quality in terms of a high proportion of small polysiloxane domains is not achievable.

(1) The objects are in particular achieved in a first embodiment of the invention by a:
Multi-stage process for continuous production of a polysiloxane-polycarbonate block copolymer using precisely one special condensation reactor,
   wherein the process is characterized by the following process steps:
   (1) providing an oligocarbonate having a relative solution viscosity of 1.08 to 1.22 and having an OH group content of 1000 to 2500 ppm,
   (2) mixing the oligocarbonate from step (1) with a hydroxyaryl-terminated polysiloxane to provide a reaction mixture containing an oligocarbonate and a hydroxyaryl-terminated polysiloxane,
   (3) introducing the reaction mixture provided in step (2) containing an oligocarbonate and a hydroxylaryl-terminated polysiloxane into the precisely one special condensation reactor, wherein the special condensation reactor comprises a reaction chamber having a shaft with at least one spreader at the circumference, wherein the spreader has an outer edge, and wherein the outer edge of the at least one spreader rotates at a defined distance from the outer wall of the reaction chamber,
   (4) reacting the reaction mixture from step (3) to afford a polysiloxane-polycarbonate block copolymer, wherein the reaction mixture is conveyed from the inlet of the special condensation reactor to the outlet of the special condensation reactor,
   (5) discharging the polysiloxane-polycarbonate block copolymer obtained from step (4) from the special condensation reactor,
   wherein in step (4) in the precisely one special condensation reactor the following process conditions are observed:
   (4.a) pressure in the reaction chamber of 0.01 mbara to 10 mbara,
   (4.b) temperature of the reaction mixture in the reaction chamber of 280° C. to 380° C., preferably of 290° C. to 370° C.,
   (4.c) circumferential velocity of the at least one spreader at the circumference of the axially extending rotationally symmetrical reaction chamber inner surface area of the reactor of 1 to 5 m/s,
   wherein the application rate of reaction mixture to the reaction chamber is from 20 kg/m²h to 100 kg/m²h,
   and
   wherein before the introducing according to step (3) of the reaction mixture containing oligocarbonate and hydroxyaryl-terminated polysiloxane provided in step (2) this reaction mixture is admixed with an amount, based on the mass of the hydroxyaryl-terminated polysiloxane, of 5*10⁷ mol to 1*10⁻³ mol of co-catalyst per kg of hydroxyaryl-terminated polysiloxane,
preferably of
1*10⁻⁶ mol to 5*10⁻⁴ mol of co-catalyst per kg of hydroxyaryl-terminated polysiloxane,
particularly preferably of
5*10⁻⁶ mol to 2*10⁻⁴ mol of co-catalyst per kg of hydroxyaryl-terminated polysiloxane,
very particularly preferably of
1*10⁻⁵ mol to 1*10⁻⁴ mol of co-catalyst per kg of hydroxyaryl-terminated polysiloxane,
wherein this co-catalyst is selected from one or more co-catalysts based on alkali metals and/or alkaline earth metals.

(2) Alternatively the objects are achieved in a second embodiment of the invention by a:
Multi-stage process for continuous production of a polysiloxane-polycarbonate block copolymer using a number of serially arranged special condensation reactors 1,
   wherein the process is characterized by the following process steps:
   (1) providing an oligocarbonate having a relative solution viscosity of 1.08 to 1.22 and having an OH group content of 1000 to 2500 ppm,
   (2) mixing the oligocarbonate from step (1) with a hydroxyaryl-terminated polysiloxane to provide a reaction mixture containing an oligocarbonate and a hydroxyaryl-terminated polysiloxane,
   (3) introducing the reaction mixture provided in step (2) containing an oligocarbonate and a hydroxylaryl-terminated polysiloxane into the first of a number of serially arranged special condensation reactors, wherein each of the number of serially arranged special condensation reactors comprises a reaction chamber having a shaft with at least one spreader at the circumference, wherein the spreader has an outer edge, and wherein the outer edge of the at least one spreader rotates at a defined distance from the outer wall of the reaction chamber,
   (4) reacting the reaction mixture from step (3) to afford a polysiloxane-polycarbonate block copolymer, wherein the reaction mixture is conveyed from the inlet of the first special condensation reactor to the outlet of the last special condensation reactor of the number of serially arranged special condensation reactors,
   (5) discharging the polysiloxane-polycarbonate block copolymer obtained from step (4) from the last special condensation reactor,
   wherein in step (4) in the last of the number of serially arranged special condensation reactors the following process conditions are observed:
   (4.a) pressure in the reaction chamber of 0.01 mbara to 10 mbara,
   (4.b) temperature of the reaction mixture in the reaction chamber of 280° C. to 380° C., preferably of 290° C. to 370° C.,
   (4.c) circumferential velocity of the at least one spreader at the circumference of the axially extending rotationally symmetrical reaction chamber inner surface area of the reactor of 1 to 5 m/s,
   wherein the application rate of reaction mixture to the reaction chambers is from 20 kg/m²h to 100 kg/m²h,
   and
   wherein before the introducing according to step (3) of the reaction mixture containing oligocarbonate and hydroxyaryl-terminated polysiloxane provided in step (2) this reaction mixture is admixed with an amount, based on the mass of the hydroxyaryl-terminated polysiloxane, of 5*10⁻⁷ mol to 1*10⁻³ mol of co-catalyst per kg of hydroxyaryl-terminated polysiloxane,
preferably of
1*10⁻⁶ mol to 5*10⁻⁴ mol of co-catalyst per kg of hydroxyaryl-terminated polysiloxane,
particularly preferably of
5*10⁻⁶ mol to 2*10⁻⁴ mol of co-catalyst per kg of hydroxyaryl-terminated polysiloxane,
very particularly preferably of
1*10⁻⁵ mol to 1*10⁻⁴ mol of co-catalyst per kg of hydroxyaryl-terminated polysiloxane,
wherein this co-catalyst is selected from one or more co-catalysts based on alkali metals and/or alkaline earth metals.

Both in the first embodiment of the process according to the invention and in the second embodiment of the process according to the invention it is the case that when the co-catalyst is a sodium-based co-catalyst the amount of the added co-catalyst is in particular 1*10⁻⁶ mol to 2*10⁻⁴ mol of co-catalyst per kg of hydroxyaryl-terminated polysiloxane and very particularly 1*10⁻⁵ mol to 1*10⁻⁴ mol of co-catalyst per kg of hydroxyaryl-terminated polysiloxane.

Both in the first embodiment of the process according to the invention and in the second embodiment of the process according to the invention it is the case that the layer thickness of a reaction mixture present on the reaction chamber inner surface area is at least 0.5 mm and at most 20 mm, preferably at least 1 mm and at most 10 mm, particularly preferably at least 1.5 mm and at most 6 mm, very particularly preferably at least 3 mm and at most 4 mm.

Both in the first embodiment of the process according to the invention and in the second embodiment of the process according to the invention it is the case here that the thickness of a layer of a reaction mixture present on the reaction chamber inner surface area need not be identical at every point but rather the layer may comprise elevations and depressions, i.e. regions of higher layer thickness and regions of lower layer thickness, for example in the form of waves. These elevations and depressions in the layer of the reaction mixture are preferably spread out by the motion of the rotor on the reaction chamber inner surface area. Such elevations and depressions are preferable since they improve mass transfer and increase the surface area of the layer of the reaction mixture which in turn facilitates the removal of the hydroxyl compound formed during the polycondensation, generally phenol.

Both in the first embodiment of the process according to the invention and in the second embodiment of the process according to the invention it is the case that:

Pressure measurement may be effected using for example WIKA IS-3 or Endress+Hauser Cerabar pressure sensors. It is however also possible to use other suitable prior art pressure sensors known to those skilled in the art.

In the context of the present invention the term “mbara” stands for the unit “mbar absolute” for reporting absolute pressure in mbar.

Measurement of the temperature of the reaction mixture may be effected for example using type L thermocouples or Pt100 resistance thermometers whose measurement tip is immersed sufficiently deep into the reaction mixture. It is however also possible to use other suitable prior art means of temperature measurement known to those skilled in the art. Temperature measurement in the interior of the thin-film evaporator may be effected here in the manner known from EP3318311A1.

The speed of rotation may preferably be measured via an initiator/pulser from the prior art on the rotor in a manner known to those skilled in the art. It is however also possible to use other suitable prior art tachometers known to those skilled in the art. The frequency of surface renewal is obtained by multiplying the speed of rotation by the number of wiper blade elements at the circumference.

In the second embodiment of the present invention the number of serially arranged special condensation reactors may be two or three or four or more serially arranged special condensation reactors.

It is preferable according to the invention when in the second embodiment of the present invention the number of serially arranged special condensation reactors is precisely two.

Both in the first embodiment of the process according to the invention and in the second embodiment of the process according to the invention it is the case that the reaction mixture in process step (1) and the polysiloxane-polycarbonate block copolymer obtained upon discharge from the last special condensation reactor of a number of serially arranged special condensation reactors and the reaction mixtures intermediately formed from the reaction mixture in process step (1) in the reaction to afford the polysiloxane-polycarbonate block copolymer are in molten form. Here, in the first embodiment of the process according to the invention the sole special condensation reactor may be regarded as the last special condensation reactor.

A special condensation reactor employable according to the invention is preferably a thin-film evaporator which is characterized in that the thin-film evaporator comprises at least two wiper blade elements at the circumference which are rotatable in the thin-film evaporator. The thin-film evaporator preferably comprises more than two wiper blade elements, in particular three, four or more wiper blade elements, at the circumference which are rotatable in the thin-film evaporator.

At least a portion of the axially extending rotationally symmetrical inner surface area of the axially extending rotationally symmetrical reaction chamber of a thin-film evaporator also serves as a heat transfer area. Heat may be supplied to the reaction chamber via the heat transfer area or heat may be removed from the reaction chamber via the heat transfer area. In a thin-film evaporator the proportion of the axially extending rotationally symmetrical inner surface area of the axially extending rotationally symmetrical reaction chamber to which reaction mixture is applied which serves as heat transfer area is from 90% to 100%, preferably 100%. The respective heat transfer area of a thin-film evaporator is a feature which is unambiguously specified for the individual thin-film evaporator by the manufacturer as a consequence of construction and is determinable by simple measurement but may be unambiguously altered by the user, for example through partial or total non-use of heating apparatuses.

Here, both in the first embodiment of the process according to the invention and in the second embodiment of the process according to the invention the temperature of the heat transfer area is from 280° C. to 350° C., preferably from 290° C. to 340° C., so that any heat formed in process step (4) during the reaction of the reaction mixture, for example through the shear of the reaction mixture, may be removed via the heat transfer area. Here, the heat transfer area may have a temperature profile or have two or more temperature zones or both.

Both in the first embodiment of the process according to the invention and in the second embodiment of the process according to the invention the residence time of the reaction mixture in step (4) is preferably 6 to 12 minutes, particularly preferably 7 to 10 minutes.

Both in the first embodiment of the process according to the invention and in the second embodiment of the process according to the invention the polysiloxane-polycarbonate block copolymers produced therewith are thus obtainable in short residence times.

According to the invention the term “intermediate polysiloxane-polycarbonate block copolymer” as is for example intermediately formed in step (4)—i.e. after introduction according to step (3) and before discharging in step (5)—is used for differentiation from the polysiloxane-polycarbonate block copolymer as obtained during discharging from the special condensation reactor according to step (5).

The term “intermediate” is accordingly used to make it clear that the intermediate polysiloxane-polycarbonate block copolymer has a lower molecular weight than the polysiloxane-polycarbonate block copolymer. The intermediate polysiloxane-polycarbonate block copolymer thus has a lower relative solution viscosity than the polysiloxane-polycarbonate block copolymer obtained at the outlet of the special condensation reactor according to step (5). The intermediate polysiloxane-polycarbonate block copolymer preferably has a relative solution viscosity of 1.20 to 1.27. It is apparent to a person skilled in the art that the use of an oligocarbonate having a lower relative solution viscosity generally also results in an intermediate polysiloxane-polycarbonate block copolymer having a lower relative solution viscosity being obtained. It is also apparent to a person skilled in the art that the intermediate polysiloxane-polycarbonate block copolymer also contains further condensed oligocarbonate having a higher relative solution viscosity than the oligocarbonate employed in step (1).

In the second embodiment of the process according to the invention it is the case that:
two serially arranged special condensation reactors are successively traversed by a reaction mixture for producing the polysiloxane-polycarbonate block copolymer and these special condensation reactors are directly connected to one another via a pipe conduit. It is preferable when no further reactor is present between these two special condensation reactors. However, pumps or mixing elements, for example static or dynamic mixers, may be employed in the connection between the special condensation reactors. These pumps or these mixing elements are not considered reactors since the purpose of these pumps or these mixing elements is merely a mechanical treatment of a substance. The second special condensation reactor may be followed by a further special condensation reactor or two or more further special condensation reactors, all arranged in series.

Both the polysiloxane-polycarbonate block copolymer obtained according to the first embodiment of the process according to the invention and the polysiloxane-polycarbonate block copolymer obtained according to the second embodiment of the process according to the invention has a high proportion of small polysiloxane domains, i.e.
both in the polysiloxane-polycarbonate block copolymer obtained according to the first embodiment of the process according to the invention and in the polysiloxane-polycarbonate block copolymer obtained according to the second embodiment of the process according to the invention the numerical proportion of polysiloxane domains larger than or equal to 12 nm and smaller than 200 nm is more than 99.0%, preferably more than 99.2%, particularly preferably more than 99.5% and very particularly preferably more than 99.9%, in each case based on the total number of polysiloxane domains larger than or equal to 12 nm.

While the polysiloxane-polycarbonate block copolymers produced according to the invention may have a high number of polysiloxane domains having a diameter of less than 12 nm these polysiloxane domains are inconsequential to the disadvantages described further above for a numerically high proportion of polysiloxane domains of 200 nm and larger.

Both the polysiloxane-polycarbonate block copolymer obtained according to the first embodiment of the process according to the invention and the polysiloxane-polycarbonate block copolymer obtained according to the second embodiment of the process according to the invention is thus superior to polysiloxane-polycarbonate block copolymers from the prior art having a polysiloxane content of 2% to 15% by weight, especially to polysiloxane-polycarbonate block copolymers from the prior art having a polysiloxane content of 3% to 10% by weight and especially to polysiloxane-polycarbonate block copolymers from the prior art having a polysiloxane content of 4% to 8% by weight, wherein the polysiloxane content refers to the total weight of the polysiloxane-polycarbonate block copolymer. This is the case especially when comparing a polysiloxane-polycarbonate block copolymer produced according to the invention with a polysiloxane-polycarbonate block copolymer produced by the melt transesterification process.

Provided that the polysiloxane-polycarbonate block copolymer produced by the process according to the invention has a polysiloxane content of 4.5% to 5.5% by weight this polysiloxane-polycarbonate block copolymer has a relative solution viscosity of 1.24 to 1.34, preferably of 1.26 to 1.33, particularly preferably of 1.27 to 1.325, wherein here too it is the case that:
both the polysiloxane-polycarbonate block copolymer obtained according to the first embodiment of the process according to the invention and the polysiloxane-polycarbonate block copolymer obtained according to the second embodiment of the process according to the invention has a high proportion of small polysiloxane domains, i.e.
both in the polysiloxane-polycarbonate block copolymer obtained according to the first embodiment of the process according to the invention and in the polysiloxane-polycarbonate block copolymer obtained according to the second embodiment of the process according to the invention the numerical proportion of polysiloxane domains larger than or equal to 12 nm and smaller than 200 nm is more than 99.0%, preferably more than 99.2%, particularly preferably more than 99.5% and very particularly preferably more than 99.7%, in each case based on the total number of polysiloxane domains larger than or equal to 12 nm.

The advantageous relative solution viscosity of a polysiloxane-polycarbonate block copolymer produced by the process according to the invention having a polysiloxane content in a very particularly preferred range from 4.5% to 5.5% by weight means that the abovementioned advantages of such a polysiloxane-polycarbonate block copolymer are attained to a particular extent. In particular, such a polysiloxane-polycarbonate block copolymer is particularly readily processable, for example by injection moulding or extrusion.

Here, the very particularly preferred range is selected such that a polysiloxane-polycarbonate block copolymer having this polysiloxane content in conjunction with the specified relative solution viscosity can achieve good mechanical properties and good processability. The relative solution viscosity which is elevated especially in the case of higher polysiloxane contents can have the result that processability is no longer optimal. However, it is possible through admixture of conventional polycarbonate having a lower relative solution viscosity to establish a polysiloxane content which corresponds to the very particularly preferred range. Such a mixture then once again features the good mechanical properties in conjunction with good flowability.

In a further processing step the polysiloxane-polycarbonate block copolymer obtained by the process according to the invention may be compounded with colourants and additions and optionally with further polycarbonate. A person skilled in the art is familiar with the mixing/compounding of conventional polycarbonate with a polysiloxane-polycarbonate block copolymer, especially also which relative solution viscosity the conventional polycarbonate must have to achieve the desired relative solution viscosity of a mixture of conventional polycarbonate with a polysiloxane-polycarbonate block copolymer. The particularly preferred range of the polysiloxane content is thus not limiting since especially at high polysiloxane contents in the polysiloxane-polycarbonate block copolymer the preferred combination of polysiloxane content and relative solution viscosity is achievable through prior art compounding of a polysiloxane-polycarbonate block copolymer with conventional polycarbonate. However, it is also the case that at excessive values of relative solution viscosity of a polysiloxane-polycarbonate block copolymer having a high polysiloxane content this high value of relative solution viscosity cannot be reduced to values of relative solution viscosity at which good processability of the polysiloxane-polycarbonate block copolymer is still assured by admixture of conventional polycarbonate having a lower relative solution viscosity.

A polysiloxane-polycarbonate block copolymer produced by the process according to the invention also exhibits tough fracture behaviour down to −60° C. in the notched impact test according to ISO 7391/ISO 180A, even at low polysiloxane contents, i.e. at polysiloxane contents of less than 5% by weight.

It is surprising that a polysiloxane-polycarbonate block copolymer produced by the process according to the invention has such a high proportion of small polysiloxane domains and exhibits such good properties since the high application rate for reaction mixture to the reaction chamber of 20 kg/m²h to 100 kg/m²h would not have been expected to result in a polysiloxane-polycarbonate block copolymer having such good features and properties. This is especially the case in light of the short residence times in the special condensation reactor/the special condensation reactors.

It is also surprising that such a small addition of co-catalyst results in a polysiloxane-polycarbonate block copolymer having such good features and properties.
(3) Both in the first embodiment of the process according to the invention and in the second embodiment of the process according to the invention it is the case that
the co-catalyst is added to the hydroxyaryl-terminated polysiloxane in the specified amount already before step (2).
(4) It is further preferable here according to the invention when in process step (4) in the single special condensation reactor or in the last special condensation reactor of a number of serially arranged special condensation reactors the following process condition is observed:
(4.a) that the pressure in the reaction chamber of the special reaction reactor is from 0.1 mbara to 6 mbara, preferably from 0.2 mbara to 2 mbara.
This more preferred embodiment of the process according to the invention is a fourth embodiment according to the abovementioned first embodiment or the abovementioned second embodiment.
(5) It is also preferable here according to the invention when the relative solution viscosity of the oligocarbonate provided in step (1) is from 1.11 to 1.22, particularly preferably 1.13 to 1.20.
This very particularly preferred embodiment of the process according to the invention is a fifth embodiment according to the abovementioned first embodiment or the abovementioned second embodiment.
(6) It is further preferable here according to the invention when the polysiloxane content of both the polysiloxane-polycarbonate block copolymer produced according to the first embodiment of the process according to the invention and the polysiloxane-polycarbonate block copolymer produced according to the second embodiment of the process according to the invention is from 2% to 15% by weight, wherein the polysiloxane content is based on the total weight of the polysiloxane-polycarbonate block copolymer.
This more preferred embodiment of the process according to the invention is a sixth embodiment according to the abovementioned first embodiment or the abovementioned second embodiment.
(7) It is particularly preferable here according to the invention when the polysiloxane content of the polysiloxane-polycarbonate block copolymer is from 3% to 10% by weight, wherein the polysiloxane content is based on the total weight of the polysiloxane-polycarbonate block copolymer.
This particularly preferred embodiment of the process according to the invention is a seventh embodiment according to the abovementioned sixth embodiment.
(8) It is very particularly preferable here according to the invention when the polysiloxane content of the polysiloxane-polycarbonate block copolymer is from 4% to 8% by weight, wherein the polysiloxane content is based on the total weight of the polysiloxane-polycarbonate block copolymer.
This very particularly preferred embodiment of the process according to the invention is an eighth embodiment according to the abovementioned sixth embodiment.
(9) It is especially very particularly preferable here according to the invention when the polysiloxane content of the polysiloxane-polycarbonate block copolymer is from 4.5% to 5.5% by weight, wherein the polysiloxane content is based on the total weight of the polysiloxane-polycarbonate block copolymer.
This especially very particularly preferred embodiment of the process according to the invention is a ninth embodiment according to the abovementioned sixth embodiment.
(10) It is further preferable here according to the invention when the OH group content of the oligocarbonate provided in step (1) is from 1200 to 2300 ppm, particularly preferably from 1400 to 2200 ppm.
This more preferred embodiment of the process according to the invention is a tenth embodiment according to the abovementioned first embodiment or the abovementioned second embodiment.
(11) It is additionally preferable here according to the invention when in step (1) the reaction mixture containing an oligocarbonate having a relative solution viscosity of 1.08 to 1.22, preferably having a relative solution viscosity of 1.11 to 1.22, particularly preferably having a relative solution viscosity of 1.13 to 1.20, and having an OH group content of 1000 to 2500 ppm, preferably having an OH group content of 1200 to 2300 ppm, particularly preferably having an OH group content of 1400 to 2200 ppm, and containing a hydroxyaryl-terminated polysiloxane is produced using dynamic and/or static mixers.
This additionally preferred embodiment of the process according to the invention is an eleventh embodiment according to the abovementioned first embodiment or the abovementioned second embodiment.
(12) In the case where the number of serially arranged special condensation reactors is at least two the following process conditions are preferably observed in step (4) of the process:
   in the first special condensation reactor:
   (4.1.a) pressure in the reaction chamber of 1 mbara to 10 mbara,
   (4.1.b) temperature of the reaction mixture in the reaction chamber of 270° C. to 350° C.,
   (4.1.c) frequency of surface renewal of the reaction mixture of 10 to 30 Hz, and in the last special condensation reactor:
   (4.2.a) pressure in the reaction chamber of 0.1 mbara to 3 mbara, preferably 0.2 to 2 mbara,
   (4.2.b) temperature of the reaction mixture in the reaction chamber of 280° C. to 370° C.,
   (4.2.c) frequency of surface renewal of the reaction mixture of 10 to 30 Hz,
   wherein the application rate of reaction mixture to the reaction chambers is from 30 kg/m²h to 60 kg/m²h.
   This embodiment of the process according to the invention is a twelfth embodiment according to the abovementioned second embodiment.

It is the case here that the layer thickness of the reaction mixture present on the reaction chamber inner surface area is at least 1 mm and at most 10 mm, particularly preferably at least 1.5 mm and at most 6 mm, very particularly preferably at least 3 mm and at most 4 mm.

The present invention further provides a polysiloxane-polycarbonate block copolymer comprising the following features:
the polysiloxane content is from 2% to 15% by weight based on the total weight of the polysiloxane-polycarbonate block copolymer,
the numerical proportion of polysiloxane domains larger than or equal to 12 nm and smaller than 200 nm is more than 99.0%, preferably more than 99.2%, particularly preferably more than 99.5% and very particularly preferably more than 99.9%, in each case based on the total number of polysiloxane domains larger than or equal to 12 nm.

This polysiloxane-polycarbonate block copolymer here has a relative solution viscosity of 1.24 to 1.34, preferably of 1.26 to 1.33, particularly preferably of 1.27 to 1.325.

The present invention further provides a polysiloxane-polycarbonate block copolymer comprising the following features:
the polysiloxane content is from 3% to 10% by weight based on the total weight of the polysiloxane-polycarbonate block copolymer,
the numerical proportion of polysiloxane domains larger than or equal to 12 nm and smaller than 200 nm is more than 99.0%, preferably more than 99.2%, particularly preferably more than 99.5% and very particularly preferably more than 99.9%, in each case based on the total number of polysiloxane domains larger than or equal to 12 nm.

At the same time this polysiloxane-polycarbonate block copolymer has a relative solution viscosity of 1.24 to 1.34, preferably of 1.26 to 1.33, particularly preferably of 1.27 to 1.325.

The present invention further provides a polysiloxane-polycarbonate block copolymer comprising the following features:
the polysiloxane content is from 4% to 8% by weight based on the total weight of the polysiloxane-polycarbonate block copolymer,
the numerical proportion of polysiloxane domains larger than or equal to 12 nm and smaller than 200 nm is more than 99.0%, preferably more than 99.2%, particularly preferably more than 99.5% and very particularly preferably more than 99.9%, in each case based on the total number of polysiloxane domains larger than or equal to 12 nm.

At the same time this polysiloxane-polycarbonate block copolymer has a relative solution viscosity of 1.24 to 1.34, preferably of 1.26 to 1.33, particularly preferably of 1.27 to 1.325.

The present invention further provides a polysiloxane-polycarbonate block copolymer comprising the following features:
the polysiloxane content is from 4.5% to 5.5% by weight based on the total weight of the polysiloxane-polycarbonate block copolymer,
the numerical proportion of polysiloxane domains larger than or equal to 12 nm and smaller than 200 nm is more than 99.0%, preferably more than 99.2%, particularly preferably more than 99.5% and very particularly preferably more than 99.9%, in each case based on the total number of polysiloxane domains larger than or equal to 12 nm.

At the same time this polysiloxane-polycarbonate block copolymer has a relative solution viscosity of 1.24 to 1.34, preferably of 1.26 to 1.33, particularly preferably of 1.27 to 1.325.

The present invention further provides for the use of the polysiloxane-polycarbonate block copolymer according to the invention for producing shaped bodies such as for example housings, helmets, dishwasher-resistant household goods, viewing windows of kettles, control knobs and buttons, snap closures, cake and chocolate moulds, plug connectors for photovoltaic plants, couplings for photovoltaic plants.

In terms of the use for producing housings the polysiloxane-polycarbonate block copolymer according to the invention is suitable for producing housings for the following articles:
medical devices, mobile electrical handheld devices, mobile scanners, mobile Play-Stations, mobile music players, wearables, sensors or computer devices for the Internet of Things, mobile electrical charging devices, mobile electrical adapters, control means for mechanical engineering, smart meters, mobile wireless devices, tablet computers, charging stations for electrical devices, antenna housings for 5G base stations, exterior electrical applications, electrical junction boxes, cash machines, parking meters.

The oligocarbonate to be employed according to the invention and the hydroxyaryl-terminated polysiloxane to be employed according to the invention are reacted with one another using co-catalysts in step (4).

Catalysts suitable for the process according to the invention for producing the oligocarbonate, in particular an oligocarbonate based on bisphenol A as a diphenol monomer unit and diphenyl carbonate (DPC), include for example:
ammonium catalysts such as for example tetramethylammonium hydroxide, tetramethylammonium acetate, tetramethylammonium fluoride, tetramethylammonium tetraphenylboranate, dimethyldiphenylammonium hydroxide, tetraethylammonium hydroxide, cetyltrimethylammonium tetraphenylboranate and cetyltrimethylammonium phenoxide. Especially suitable catalysts also include phosphonium catalysts of formula (K):

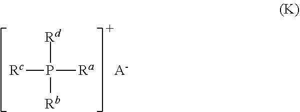

wherein R^{a}, R^{b}, R^{c} and R^{d} may be identical or different C1-C10-alkyls, C6-C14-aryls, C7-C15-arylalkyls or C5-C6-cycloalkyls, preferably methyl or C6-C14-aryls, particularly preferably methyl or phenyl, and A⁻ may be an anion such as hydroxide, sulfate, hydrogensulfate, hydrogencarbonate, carbonate or a halide, preferably chloride or an alkoxide or aroxide of formula —OR, wherein R may be a C6-C14-aryl, C7-C15-arylalkyl or C5-C6-cycloalkyl, preferably phenyl.

Particularly preferred catalysts are tetraphenylphosphonium chloride, tetraphenylphosphonium hydroxide or tetraphenylphosphonium phenoxide; tetraphenylphosphonium phenoxide is very particularly preferred. It is particularly preferable to employ the alkali metal salts or alkaline earth metal salts of these ammonium and/or phosphonium catalysts.

The catalyst is preferably employed in amounts of 0.0001% to 1.0% by weight, preferably of 0.001% to 0.5% by weight, especially preferably of 0.005% to 0.3% by weight and very particularly preferably of 0.01% to 0.15% by weight based on the weight of the employed oligocarbonate.

The catalyst may be employed alone or as a catalyst mixture and may be added in pure form or as a solution, for example in water or in phenol, for example as a solid solution with phenol. It may be introduced into the reaction for example by means of a masterbatch preferably with the oligocarbonate or added separately/in addition.

It is likewise preferable when the oligocarbonate and the hydroxyaryl-terminated polysiloxane are reacted in the presence of an organic or inorganic salt of a weak acid having a pK_{A} in the range from 3 to 7 (25° C.). This salt is also referred to as co-catalyst in the context of the present invention. Suitable weak acids comprise carboxylic acids, preferably C2-C22-carboxylic acids such as for example acetic acid, propanoic acid, oleic acid, stearic acid, lauric acid, benzoic acid, 4-methoxybenzoic acid, 3-methylbenzoic acid, 4-tert-butylbenzoic acid, p-tolueneacetic acid, 4-hydroxybenzoic acid and salicylic acid, partial esters of polycarboxylic acids, for example monoesters of succinic acid, partial esters of phosphoric acids, for example mono- or diorganic phosphoric esters, branched aliphatic carboxylic acids, such as for example 2,2-dimethylpropionic acid, 2,2-dimethylbutanoic acid, 2,2-dimethylpentanoic acid and 2-ethylhexanoic acid.

Suitable organic or inorganic salts are selected from or derived from hydrogencarbonate, potassium hydrogencarbonate, lithium hydrogencarbonate, sodium carbonate, potassium carbonate, lithium carbonate, sodium acetate, potassium acetate, lithium acetate, sodium stearate, potassium stearate, lithium stearate, sodium oleate, potassium oleate, lithium oleate, sodium benzoate, potassium benzoate, lithium benzoate, disodium, dipotassium or dilithium salts of bisphenol A. The salts may further comprise calcium hydrogencarbonate, barium hydrogencarbonate, magnesium hydrogencarbonate, strontium hydrogencarbonate, calcium carbonate, barium carbonate, magnesium carbonate, strontium carbonate, calcium acetate, barium acetate, magnesium acetate, strontium acetate, calcium stearate, barium stearate, magnesium stearate, strontium stearate and the corresponding oleates. All these salts may be used alone or in any desired mixtures.

The salt is particularly preferably selected from the group consisting of alkali metal salts, alkaline earth metal salts and phosphonium salts of carboxylic acids. In a further preferred embodiment the organic or inorganic salt is derived from a carboxylic acid.

According to the invention the organic or inorganic salts are employed in amounts of 5*10⁻⁷ mol to 1*10⁻³ mol of co-catalyst per kg of hydroxyaryl-terminated polysiloxane, preferably 1*10⁻⁶ mol to 5*10⁴ mol of co-catalyst per kg of hydroxyaryl-terminated polysiloxane, particularly preferably 5*10⁻⁶ mol to 2*10⁻⁴ mol of co-catalyst per kg of hydroxyaryl-terminated polysiloxane, very particularly preferably 1*10⁻⁵ mol to 1*10⁻⁴ mol of co-catalyst per kg of hydroxyaryl-terminated polysiloxane.

In a preferred embodiment the organic or inorganic salt is a sodium salt, preferably a sodium salt of a carboxylic acid. The co-catalyst is preferably dissolved in the hydroxyaryl-terminated polysiloxane with a suitable solvent. The sodium content of the polysiloxane-polycarbonate block copolymer may for example be determined by atomic absorption spectroscopy.

It is an advantage that the sodium content in the obtained polysiloxane-polycarbonate block copolymer is less than in the prior art since higher sodium contents can result in increased decomposition of the polysiloxane-polycarbonate block copolymer under thermal stress.

The organic or inorganic salt, i.e. the co-catalyst, may be employed alone or in any desired mixtures. It may be added as a solid or in solution. In a preferred embodiment the organic or inorganic salt is added in the form of a mixture containing the hydroxyaryl-terminated polysiloxane and the organic or inorganic salt.

The catalysts may be employed alone or in admixture with other catalysts and be added in pure form or as a solution, for example in water or in phenol. The co-catalysts may also be employed alone or in admixture with other co-catalysts and be added in pure form or as a solution.

It is especially preferable when the at least one catalyst is incorporated to the oligocarbonate and the co-catalyst is incorporated into the hydroxyaryl-terminated polysiloxane.

### Oligocarbonate (Component A)

An oligocarbonate (hereinbelow also referred to as component (A)) in the context of the present invention is preferably a homo-oligocarbonate. The oligocarbonate may be linear or branched in known fashion. Production of the oligocarbonate employed according to the invention is carried out as described above preferably by the melt transesterification process, in particular according to WO2019238419A1. Production of an oligocarbonate useful for the process according to the invention is also described in DE10119851A1, WO02077066A1, WO02077067A2 or WO02085967A1. Production of an oligocarbonate useful for the process according to the invention according to WO02085967A1, wherein the oligocarbonate is withdrawn from the mesh basket reactor forming the penultimate stage of the polycondensation to afford the polycarbonate, is especially advantageous.

To produce the polysiloxane-polycarbonate block copolymer according to the invention it is preferable to employ an oligocarbonate having a molecular weight (Mw) of 5000 to 20 000 g/mol, particularly preferably of 8 000 to 19 000 g/mol and especially preferably of 10 000 to 18 000 g/mol. This oligocarbonate preferably has a content of phenolic OH groups of 1000 ppm to 2500 ppm, preferably 1300 to 2300 ppm and especially preferably of 1400 to 2200 ppm. The phenolic OH groups are preferably determined by IR spectroscopy. In the context of the present invention ppm is to be understood as meaning parts by weight—unless otherwise stated.

The method used for determining the molar masses reported in the context of the invention for the oligocarbonate, the hydroxyaryl-terminated polysiloxane or the polysiloxane-polycarbonate block copolymer is method no. 2301-0257502-09D of Currenta GmbH & Co. OHG which is available from Currenta GmbH & Co. OHG upon request at any time.

It is also possible in the context of the present invention to calculate the molar mass of the oligocarbonate by the following formula:

Mw(oligocarbonate)[g/mol]=160 799*(solution viscosity−1)exp(1.3862).

It is further preferable when an oligocarbonate having a relative solution viscosity of 1.08 to 1.22 is employed for producing the polysiloxane-polycarbonate block copolymer according to the invention. Here, the relative solution viscosity (rirel; also referred to as eta rel) is preferably determined using an Ubbelohde viscometer in dichloromethane at a concentration of 5 g/l at 25° C.

Preferred diphenols for producing the oligocarbonate are 4,4′-dihydroxydiphenyl, 2,2-bis(4 hydroxyphenyl)-1-phenylpropane, 1,1-bis(4-hydroxyphenyl)phenylethane, 2,2-bis(4 hydroxyphenyl)propane, 2,2-bis(3-methyl-4-hydroxyphenyl)propane, 2,4-bis(4-hydroxyphenyl)-2 methylbutane, 1,3-bis[2-(4-hydroxyphenyl)-2-propyl]benzene (bisphenol M), 2,2-bis(3-methyl-4 hydroxyphenyl)propane, bis(3,5-dimethyl-4-hydroxyphenyl)methane, 2,2-bis(3,5-dimethyl-4 hydroxyphenyl)propane, bis(3,5-dimethyl-4-hydroxyphenyl)sulfone, 2,4-bis(3,5-dimethyl-4 hydroxyphenyl)-2-methylbutane, 1,3-bis[2-(3,5-dimethyl-4-hydroxyphenyl)-2-propyl]benzene, 1,1-bis(4 hydroxyphenyl)cyclohexane and 1,1-bis(4-hydroxyphenyl)-3,3,5-trimethylcyclohexane.

Particularly preferred diphenols are 2,2-bis(4-hydroxyphenyl)propane (BPA), hydroquinone, 1,1-bis(4-hydroxyphenyl)-3,3,5-trimethylcyclohexane and 2,2-bis(3-methyl-4-hydroxyphenyl)propane.

The oligocarbonate is in particular a homo-oligocarbonate based on bisphenol A as a diphenol monomer building block and diphenyl carbonate (DPC). It is very particularly preferable when this homo-oligocarbonate contains phenol as the end group.

An oligocarbonate bearing phenol as end groups (phenyl-terminated oligocarbonate) is also preferred. tert-butylphenol and cumylphenol are further possible end groups.

The polysiloxane-polycarbonate block copolymer obtainable by the process according to the invention preferably contains at least one, particularly preferably two or more, of the following structures (4) to (7):

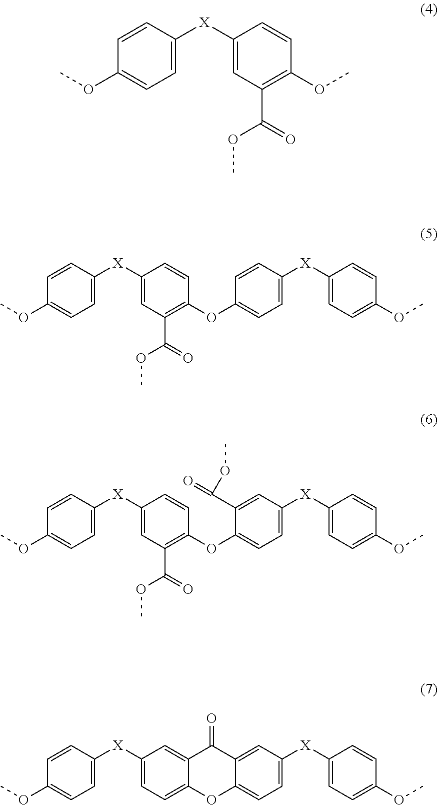

in which the phenyl rings may independently of one another be mono- or disubstituted with C1-C8 alkyl, halogen, preferably C1 to C4 alkyl, particularly preferably with methyl and X represents a single bond, C1 to C6 alkylene, C2 to C5 alkylidene or C5 to C6 cycloalkylidene, preferably a single bond or C1 to C4 alkylene and especially preferably isopropylidene, wherein the amount of structural units (4) to (7) in total (preferably determined through total hydrolysis using quantitative HPLC) is generally in the range from 50 to 1000 ppm, preferably in the range from 80 to 850 ppm. Thus also the polysiloxane-polycarbonate block copolymer produced according to the invention preferably comprises at least one, particularly preferably two or more, of the abovementioned structures (4) to (7).

In order to determine the amount of the rearrangement structures the respective polysiloxane-polycarbonate block copolymer is subjected to a total hydrolysis to form the corresponding decomposition products of formulae (4a) to (7a), the amount of which is determined by HPLC. This can be accomplished for example as follows: a polysiloxane-polycarbonate block copolymer sample is hydrolysed under reflux using sodium methoxide. The corresponding solution is acidified and concentrated to dryness. The drying residue is dissolved in acetonitrile and the phenolic compounds of formulae (4a) to (7a) are determined using HPLC with UV detection, wherein the compound of formula (4a) is a decomposition product of the compound of formula (4), and wherein the compound of formula (5a) is a decomposition product of the compound of formula (5), and wherein the compound of formula (6a) is a decomposition product of the compound of formula (6), and wherein the compound of formula (7a) is a decomposition product of the compound of formula (7), wherein for all of these cases X is assumed to be isopropylidene:

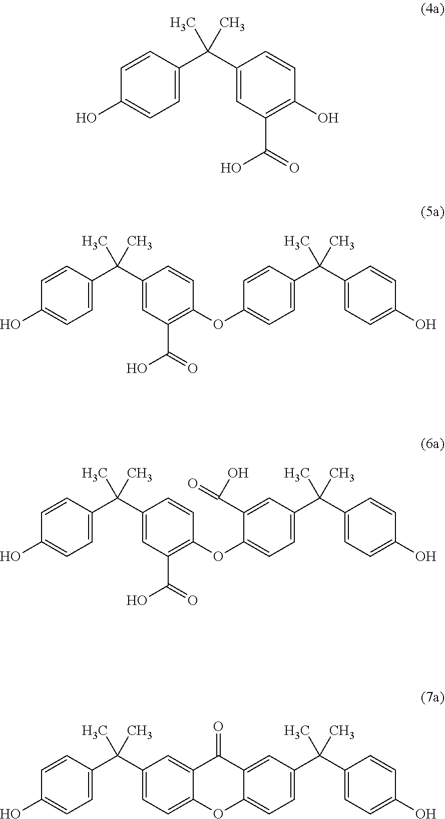 [SMILES: CC(C)(c1ccc(O)cc1)c1ccc(O)c(C(=O)O)c1 ; CC(C)(c1ccc(O)cc1)c1ccc(Oc2ccc(C(C)(C)c3ccc(O)cc3)cc2C(=O)O)cc1 ; CC(C)(c1ccc(O)cc1)c1ccc(Oc2ccc(C(C)(C)c3ccc(O)cc3)cc2C(=O)O)c(C(=O)O)c1 ; CC(C)(c1ccc(O)cc1)c1ccc2oc3ccc(C(C)(C)c4ccc(O)cc4)cc3c(=O)c2c1]

The amount of the thus liberated compound of formula (4a) is preferably 10 to 500 ppm, particularly preferably 30 to 300 ppm.

The amount of the thus liberated compound of formula (5a) is preferably 0 (i.e. below the detection limit of 10 ppm) to 100 ppm, particularly preferably 1 to 50 ppm.

The amount of the thus liberated compound of formula (6a) is preferably 1 (i.e. below the detection limit of 10 ppm) to 100 ppm, more preferably 1 to 50 ppm.

The amount of the thus liberated compound of formula (7a) is preferably 10 (i.e. at the detection limit of 10 ppm) to 300 ppm, preferably 20 to 250 ppm.

### Hydroxyaryl-Terminated Polysiloxane (Component B)

The polysiloxane used according to the invention is hydroxyaryl-terminated. This means that at least one end, preferably at least 2 ends, particularly preferably all ends (if more than 2 ends are present) of the polysiloxane have a hydroxyaryl end group.

Component B is preferably a hydroxyaryl-terminated polysiloxane of formula (1)

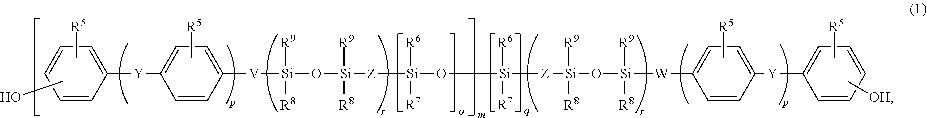

where
R⁵ is hydrogen or C₁- to C₄-alkyl, C₁- to C₃-alkoxy, preferably hydrogen; methoxy or methyl,
R⁶, R⁷, R⁸ and R⁹ each independently of one another are C₁- to C₄-alkyl or C₆- to C₁₂-aryl, preferably methyl or phenyl,
Y is a single bond, SO₂—, —S—, —CO—, —O—, C₁- to C₆-alkylene, C₂- to C₅-alkylidene, C₆- to C₁₂-arylene which may optionally be fused to further aromatic rings containing heteroatoms or is a C₅- to C₆-cycloalkylidene radical which may be mono- or polysubstituted by C₁- to C₄-alkyl, preferably is a single bond, —O—, isopropylidene or a C₅- to C₆-cycloalkylidene radical which may be mono- or polysubstituted by C₁- to C₄-alkyl,
V is oxygen, C₂- to C₆-alkylene or C₃- to C₆-alkylidene, preferably oxygen or C₃-alkylene,
p, q and r are each independently 0 or 1,
when q=0: W is a single bond and preferably simultaneously r=0,
when q=1 and r=0: W is oxygen, C₂- to C₆-alkylene or C₃- to C₆-alkylidene, preferably oxygen or C₃-alkylene,
when q=1 and r=1: W and V each independently are oxygen or C₂- to C₆-alkylene or C₃- to C₆-alkylidene, preferably C₃-alkylene,
Z is a C₁- to C₆-alkylene, preferably C₂-alkylene,
is an average number of repeating units of from 10 to 500, preferably 10 to 100, and
m is an average number of repeating units of from 1 to 10, preferably 1 to 6, more preferably 1.5 to 5. It is likewise possible to use diphenols in which two or more siloxane blocks of general formula (1 a) are joined to one another via terephthalic acid and/or isophthalic acid to form ester groups.

Especial preference is given to (poly)siloxanes of formulae (2) and (3)

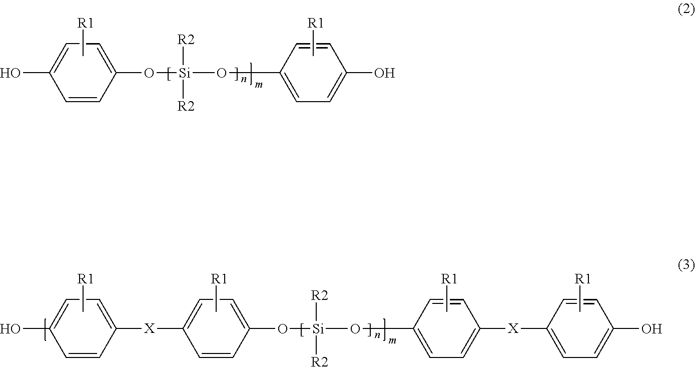

in which R1 is hydrogen, C₁- to C₄-alkyl, preferably hydrogen or methyl and especially preferably hydrogen,
each R2 independently is aryl or alkyl, preferably methyl,
X is a single bond, —SO₂—, —CO—, —O—, —S—, C₁- to C₆-alkylene, C₂- to C₅-alkylidene or C₆- to C₁₂-arylene which may optionally be fused to further aromatic rings containing heteroatoms,
X preferably is a single bond, C₁- to C₅-alkylene, C₂- to C₅-alkylidene, C₅- to C₁₂-cycloalkylidene, —O—, —SO— —CO—, —S—, —SO₂—, particularly preferably X is a single bond, isopropylidene, C₅- to C₁₂-cycloalkylidene or oxygen, and very particularly preferably is isopropylidene,
n is an average number of from 10 to 400, preferably 10 to 100, especially preferably 15 to 50 and
m is an average number of from 1 to 10, preferably from 1 to 6 and especially preferably from 1.5 to 5.

The siloxane block may likewise preferably be derived from the following structure

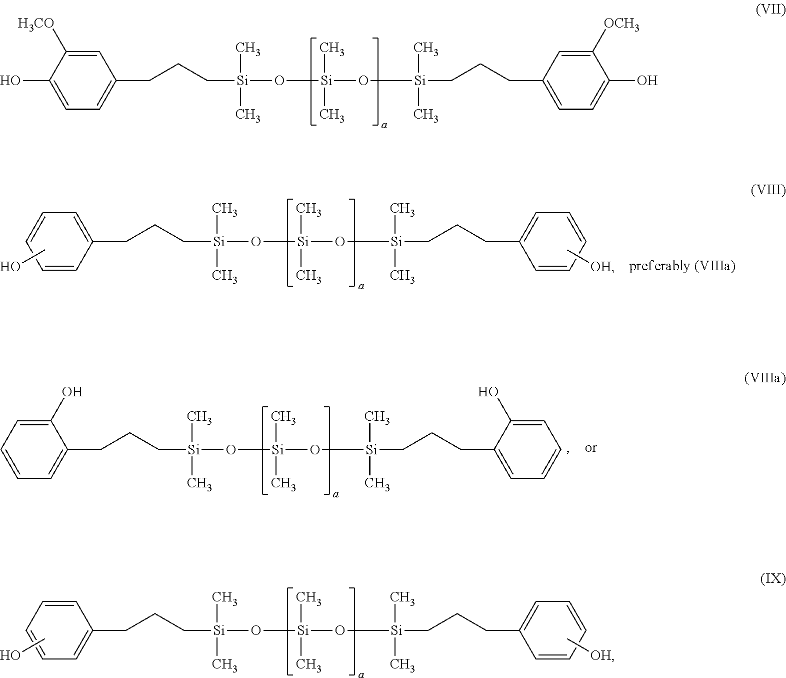

wherein a in formulae (VII), (VIII) and (IX) represents an average number from 10 to 400, preferably 10 to 100 and particularly preferably 15 to 50.

It is likewise preferable here when at least two identical or different siloxane blocks of general formulae (VII), (VIII) or (IX) are joined to one another via terephthalic acid and/or isophthalic acid to form ester groups.

It is likewise preferable when in formula (1a) p=0, V is C₃-alkylene, r=1, Z is C₂-alkylene, R⁸ and R⁹ are methyl, q=1, W is C₃-alkylene, m=1, R⁵ is hydrogen or C₁- to C₄-alkyl, preferably hydrogen or methyl, R⁶ and R⁷ each independently of one another are C₁- to C₄-alkyl, preferably methyl, and o is 10 to 500.

Production of a hydroxyaryl-terminated polysiloxane according to any of formulae (1) to (3) is described for example in EP 0 122 535 A2, U.S. Pat. No. 2,013,026 7665 A1 or WO 2015/052229 A1.

The hydroxyaryl-terminated polysiloxane of formula (1), (2) or (3) or else (VII) or (VIII) is employed in amounts of 0.5% to 50% by weight, preferably of 1% to 40% by weight, especially preferably of 2% to 20% by weight and very particularly preferably of 2.5% to 10% by weight in each case based on the sum of the masses of the oligocarbonate and the hydroxyaryl-terminated polysiloxane.

The polysiloxane-polycarbonate block copolymers obtainable by the process according to the invention and the polymer compositions further produced therefrom may be processed into any desired shaped bodies in the manner known for thermoplastic polymers, in particular polycarbonates.

In this connection the polysiloxane-polycarbonate block copolymers obtainable by the process according to the invention and the polymer compositions further produced therefrom may be converted into articles of manufacture, shaped bodies or shaped articles for example (summarized as shaped parts) by hot pressing, spinning, blow moulding, thermoforming, extruding or injection moulding. Use in multilayer systems is also of interest. Application of the composition obtainable according to the invention may be employed for example in multicomponent injection moulding or as a substrate for a coextrusion layer. However, application may also be to the ready-moulded main body, for example by lamination with a film or by coating with a solution.

Sheets or shaped bodies composed of a base layer and an optional outerlayer/optional outerlayers (multilayer systems) may be produced by (co)extrusion, direct skinning, direct coating, insert moulding, in-mould coating, or other suitable methods known to those skilled in the art.

The polysiloxane-polycarbonate block copolymer obtainable by the process according to the invention and the polymer compositions, in particular polycarbonate compositions, further produced therefrom are employable anywhere where the known aromatic polycarbonates have hitherto been used and where good flowability coupled with improved mould release characteristics, high toughness at low temperatures and better chemicals resistance are additionally required, for example for production of large motor vehicle exterior parts and control boxes for exterior application, of sheets, twin-wall sheets, of parts for electricals and electronics and of optical storage media. The polysiloxane-polycarbonate block copolymers obtainable by the process according to the invention may thus be employed in the IT sector for computer housings and multimedia housings, mobile phone housings, and in the household sector such as in washing machines or dishwashers, in the sports sector, for example as a material for helmets.

### WORKING EXAMPLES

The invention is described in more detail below by reference to working examples, without any intention to limit the invention to these examples. Here, the determination methods described below are employed for all corresponding parameters in the present invention in the absence of any statement to the contrary.

### Relative Solution Viscosity

The relative solution viscosity (rirel; also referred to as eta rel) was determined using an Ubbelohde viscometer in dichloromethane at a concentration of 5 g/l at 25° C.

Evaluation of polysiloxane Domain Size by Atomic Force Microscopy (AFM)

The polysiloxane domain size was determined by atomic force microscopy. To this end the respective sample (in the form of pellet material in extrusion batches) was cut under nitrogen cooling (−196° C.) using an ultramicrotome. A Bruker D3 100 AFM microscope was used. The AFM image was recorded at room temperature (25° C., 30% relative humidity). “Soft Intermittent Contact Mode” or “Tapping Mode” was used for the measurement. A “tapping mode cantilever” (Nanoworld pointprobe) having a spring constant of about 2.8 Nm⁻¹ and a resonance frequency of about 75 kHz was used to scan the sample. The tapping force is controlled by the ratio of the target amplitude and the free oscillation amplitude (amplitude of the probe tip with free oscillation in air). The sampling rate was set to 1 Hz. To record the surface morphology phase contrast and topography images were recorded on a 2.5 μm×2.5 μm area. The polysiloxane domains were evaluated automatically using Olympus SIS image processing software (Olympus Soft Imaging Solutions GmbH, 48149, Munster, Germany) via light-dark contrast from the phase contrast images. The diameters of the polysiloxane domains were determined via the diameter of the equivalent projection area of a circle of the cross section of the polysiloxane domain visible in the cut. The resolution for image evaluation was 12 nm.

### Starting Materials:

### Oligocarbonate (Component A)

The starting material used for producing a polysiloxane-polycarbonate block copolymer was linear bisphenol A oligocarbonate containing phenyl end groups and phenolic OH end groups having a relative solution viscosity of 1.17. This oligocarbonate did not contain any additives such as UV stabilizers, mould release agents or thermal stabilizers. The oligocarbonate was prepared via a melt transesterification method as described in WO02085967A1, and was removed immediately at the exit from the first horizontal reactor. The oligocarbonate has a phenolic end group content of 0.16%.

The oligocarbonate was dried at 120° C. for at least 2 hours in an air circulation dryer before use.

### Hydroxyaryl-Terminated Polysiloxane Containing Compatibilizer (Component B1)

The hydroxyaryl-terminated polysiloxane employed was a bisphenol A-terminated polydimethylsiloxane of formula (3) where n is between 25 and 32 and m is in the range from 2.5 to 4 (R¹=H, R²=methyl; X=isopropylidene) having a hydroxy content between 14 and 20 mg KOH/g and a viscosity between 350 and 650 mPas (23° C.); the polysiloxane is admixed with sodium benzoate, the sodium content is between 0.3 and 1.5 ppm. Per 9 parts of the hydroxyaryl-terminated polysiloxane 1 part of the siloxane Dow Corning 40-001 (Dow Corning Corporation) is added as compatibilizer.

Hydroxyaryl-Terminated Polysiloxane without Compatibilizer (Component B2)

The hydroxyaryl-terminated polysiloxane employed was a bisphenol A-terminated polydimethylsiloxane of formula (3) where n is between 25 and 32 and m is in the range from 2.5 to 4 (R¹=H, R²=methyl; X=isopropylidene) having a hydroxy content between 14 and 20 mg KOH/g and a viscosity between 350 and 650 mPas (23° C.); the polysiloxane is admixed with sodium benzoate, the sodium content is between 0.8 and 1.3 ppm.

### Experimental Setup for Example 7 and Example 8 (Inventive)

### With Precisely One Special Condensation Reactor

FIG. 4 shows the experimental setup for the experiments relating to one of the embodiments of the process according to the invention, steps (1) to (5) of the process according to the invention in the embodiment in which precisely one special condensation reactor, in this setup precisely one thin-film evaporator, is used for producing the polysiloxane-polycarbonate block copolymer by polycondensation.

An oligocarbonate (component A) and a hydroxyaryl-terminated polysiloxane containing a compatibilizer (component B1) were introduced to a plasticizing extruder (1) as a physical mixture using a gravimetric metering balance (4) in the form of pellet material and melted therein.

The thin-film evaporator (2) was evacuated using a vacuum pump (8). The offgas was passed through a condenser (9) where the condensable constituents, in particular phenol, were separated. The obtained polysiloxane-polycarbonate block copolymer was discharged from the thin-film evaporator (2) via a gear pump (3) and spun through a die plate (not shown) and pelletized.

The thin-film evaporator (2) had a reaction chamber inner surface area of 0.5 m². The reaction chamber inner surface area of the thin-film evaporator (2) was wiped over by a vertical rotor having four wiper blade elements at the circumference.

### Experimental Setup for Example 9 and 10 (Inventive)

### With Precisely Two Special Condensation Reactors

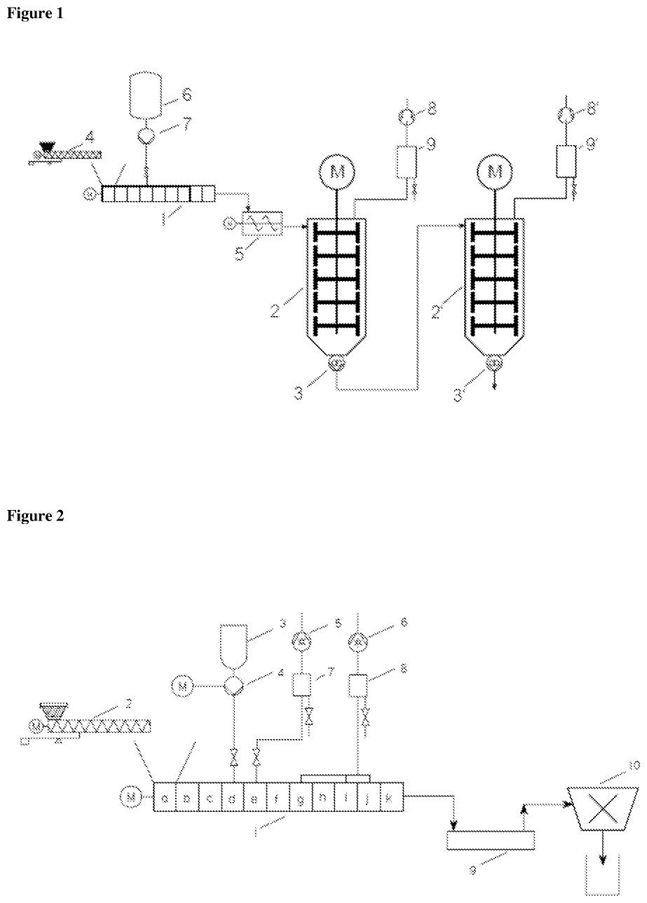

FIG. 1 shows the experimental setup for the experiments relating to one of the embodiments of the process according to the invention, steps (1) to (5) of the process according to the invention in the embodiment in which precisely two special condensation reactors, in this setup precisely two thin-film evaporators, are used for producing polysiloxane-polycarbonate block copolymer by polycondensation. An oligocarbonate (component A) was introduced to a plasticizing extruder (1) using a gravimetric metering balance (4) in the form of pellet material and melted. A hydroxyaryl-terminated polysiloxane (component B) was provided in a reservoir container (6) in liquid form and continuously metered into the plasticizing extruder (1) via a pump (7). The metering of the hydroxyaryl-terminated polysiloxane into the plasticizing extruder (1) was effected into the melt of the oligocarbonate, i.e. downstream of the plasticizing zone of the extruder (1). The plasticizing extruder performed a premixing of the components A and B. The mixture was passed to an INDAG DLS/M 007 dynamic mixer (5). The mixer was operated at 500 rpm. The obtained melt mixture was subsequently passed to a first thin-film evaporator (2). The first thin-film evaporator (2) was evacuated using a vacuum pump (9). The offgas was passed through a condenser (8) where the condensable constituents, in particular phenol, were separated. After discharging from the first thin-film evaporator (2) the obtained reaction mixture containing an intermediate polysiloxane-polycarbonate block copolymer and unconverted oligocarbonate and unconverted hydroxyaryl-terminated polysiloxane were passed to a second thin-film evaporator (2′) via a melt conduit by means of a gear pump (3). After the second thin-film evaporator (2′) the obtained polysiloxane-polycarbonate block copolymer was spun through a die plate (not shown) using a gear pump (3′) and pelletized. The second thin-film evaporator (2′) was also evacuated via a vacuum pump (9′) and condensable constituents of the offgas, in particular phenol, were separated in a condenser (8′).

The two thin-film evaporators (2) and (2′) each had a reaction chamber inner surface area of 0.5 m². The reaction chamber inner surface area of the two thin-film evaporators (2) and (2′) was each wiped over by a vertical rotor having a multiplicity of wiper blade elements, in particular precisely four wiper blade elements, at the circumference.

Experimental Setup with Twin-Screw Extruder

### (For Comparative Examples 3 and 4 and for Production of the Intermediate Polysiloxane-Polycarbonate Block Copolymer Used in Comparative Examples 1 and 2)

The scheme of the experimental setup is apparent from FIG. 2.

FIG. 2 shows a scheme for producing a polysiloxane-polycarbonate block copolymer. An oligocarbonate (component A) was metered into a twin-screw extruder (1) via a gravimetric feeder (2). The extruder (ZSE 27 MAXX from Leistritz Extrusionstechnik GmbH, Nuremberg) was a co-rotating twin-screw extruder (1) with vacuum zones for removal of the vapours. The twin-screw extruder (1) consisted of 11 barrel sections (a to k)—see FIG. 2. Addition of the oligocarbonate (component A) was carried out in barrel section a via the differential metering balance (2) and the melting of the oligocarbonate was carried out in barrels b and c. Barrel sections d and e were also used for incorporating the liquid hydroxyaryl-terminated polysiloxane (component B). Barrel sections e, g, i and j were provided with degassing openings to remove the condensation products, in particular phenol. Barrel section e was assigned to the first vacuum stage and barrel sections g, i and j were assigned to the second vacuum stage. The pressure in the first vacuum stage was from 45 to 65 mbara unless otherwise stated. The pressure in the second vacuum stage was less than 1 mbara. The hydroxyaryl-terminated polysiloxane (component B) was initially charged in a tank (3) and introduced into the twin-screw extruder (1) via a metering pump (4). The negative pressure was generated via the vacuum pumps (5) and (6). The vapours were conducted away from the twin-screw extruder (1) and passed through 2 condensers (7) and (8) where the condensation products, in particular phenol, were condensed. The melt strand of the polysiloxane-polycarbonate block copolymer was passed into a water bath (9) and comminuted by the granulator (10).

Experimental Setup with High-Viscosity Reactor

### (For Comparative Examples 5 and 6 and as a Preliminary Stage for Inventive Examples 7 to 10)

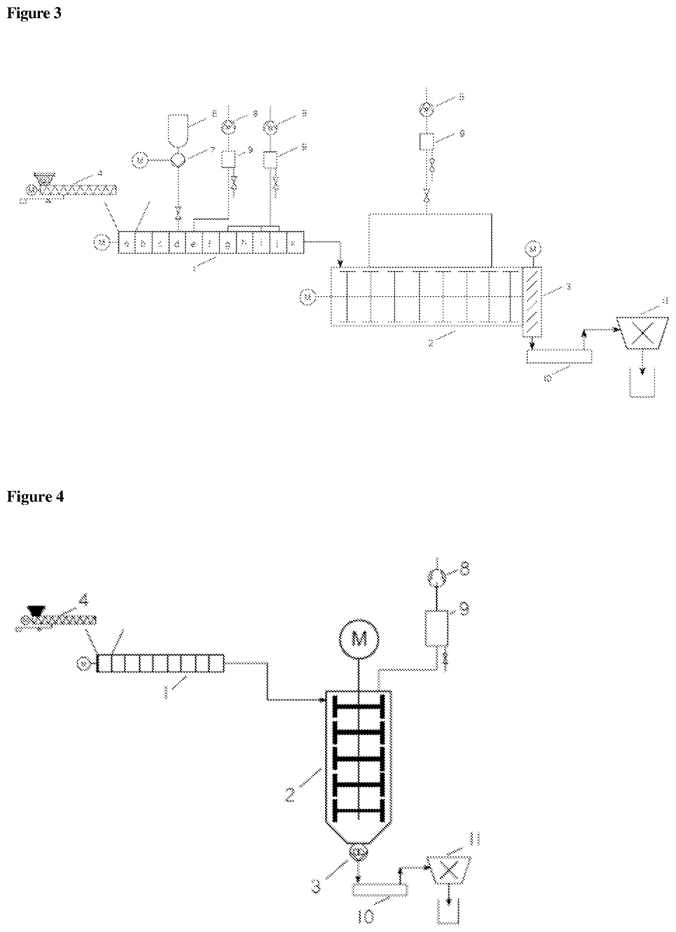

The scheme of the experimental setup is apparent from FIG. 3.

FIG. 3 shows a scheme for producing a polysiloxane-polycarbonate block copolymer. An oligocarbonate (component A) was metered into a twin-screw extruder (1) via a gravimetric supply means (4). The twin-screw extruder (1) (ZSE 27 MAXX from Leistritz Extrusionstechnik GmbH, Nuremberg) was a co-rotating twin-screw extruder with vacuum zones for removal of the vapours. The twin-screw extruder (1) consisted of 11 barrel sections (a to k)—see FIG. 3. Addition of oligocarbonate was carried out in barrel section a and the melting of this oligocarbonate was carried out in barrel sections b and c. Addition of a liquid hydroxyaryl-terminated polysiloxane (component B) was effected in barrel section d. Barrel sections e and f were used for incorporation of the liquid hydroxyaryl-terminated polysiloxane. Barrel sections g, h, i and j were provided with degassing openings to remove the condensation products. Barrel sections g and h were assigned to the first vacuum stage and barrel sections i and j were assigned to the second vacuum stage. The pressure in the first vacuum stage was from 250 to 500 mbara unless otherwise stated. The pressure in the second vacuum stage was less than 1 mbara. The hydroxyaryl-terminated polysiloxane was initially charged in a tank (6) and introduced into the twin-screw extruder (1) via a metering pump (7). The negative pressure was generated via 2 vacuum pumps (8). The vapours were conducted away from the twin-screw extruder (1) and collected in 2 condensers (9). The thus degassed and partially condensed melt was passed via a conduit from barrel section k of the twin-screw extruder (1) to a high-viscosity reactor (2).

The high-viscosity reactor (2) was a self-cleaning apparatus having two counter-rotating rotors arranged horizontally and axially parallel. The setup is described in European patent application EP0460466A1, see FIG. 7 therein. The employed high-viscosity reactor (2) had a barrel diameter of 187 mm at a length of 924 mm. The total interior of the high-viscosity reactor (2) had a volume of 44.6 litres. The high-viscosity reactor (2) was likewise connected to a vacuum pump (8) and to a condenser (9). The pressure at the high-viscosity reactor (2) was 0.1 to 5 mbara. After completion of the reaction the obtained polysiloxane-polycarbonate block copolymer was discharged via a discharge screw (3) and subsequently pelletized (via a water bath (10) and a granulator (11)).

### Comparative Example 1

Experiment with Rotating-Disc Reactor.

The experimental setup according to FIG. 2 was initially used to produce an intermediate polysiloxane-polycarbonate block copolymer. To this end 9.5 kg/h of an oligocarbonate (component A) having a relative solution viscosity of 1.17 is metered into the barrel (a) of the twin-screw extruder (1) (see FIG. 2). The hydroxyaryl-terminated polysiloxane (component B1) containing a compatibilizer and 1.2 ppm of Na based on the mass of the employed hydroxyaryl-terminated polysiloxane, corresponding to 5.22*10⁻⁵ mol of Na per kg of the employed hydroxyaryl-terminated polysiloxane, was introduced into the barrel (d) of the twin-screw extruder (1) at 0.475 kg/h. The twin-screw extruder (1) was operated at a speed of 400 rpm.

The extruder barrels were heated according to the following scheme: Barrel (a) unheated, barrel (b) 170° C., barrels (c) and (d) 240° C., barrel (e) 250° C., barrel (f) 260° C., barrels (g) and (h) 270° C., barrel (i) 275° C., barrel (j) 285° C. and barrel (k) 295° C. A pressure of 40 mbara was applied to barrel (e). A pressure of 0.6 mbara was applied to the barrels (g), (i) and (j). The intermediate polysiloxane-polycarbonate block copolymer was extruded at a melt temperature of 323° C., passed through the water bath (10) and pelletized.

10 kg of the intermediate polysiloxane-polycarbonate block copolymer thus produced were melted in a rotating-disc reactor from Uhde Inventa Fischer GmbH having 2 discs, each of 800 mm in diameter. The melt was polycondensed in the rotating-disc reactor at 300° C. and 1 mbara for 87 minutes at a rotor speed of 2.5 rpm. Phenol was continuously removed. The obtained polysiloxane-polycarbonate block copolymer was discharged and pelletized. The thus obtained polysiloxane-polycarbonate block copolymer has a relative solution viscosity of eta rel 1.26.

The discs of the reactor have a surface area to which the reaction mixture is applied of 2 m². The application rate based on the surface area to which the reaction mixture is applied is 3.4 kg/m²h.

### Comparative Example 2

Experiment with Rotating-Disc Reactor.

10 kg of an intermediate polysiloxane-polycarbonate block copolymer (FIG. 2) produced using the twin-screw extruder (1) as in comparative example 1 were melted in the rotating-disc reactor from comparative example 1. The intermediate polysiloxane-polycarbonate block copolymer was polycondensed in the rotating-disc reactor at 300° C. and 1 mbar for 110 minutes at a speed of 2.5 rpm. Phenol was continuously removed. The obtained polysiloxane-polycarbonate block copolymer was discharged and pelletized. The thus obtained polysiloxane-polycarbonate block copolymer has a relative solution viscosity of eta rel 1.33.

The sizes of the polysiloxane domains in the polysiloxane-polycarbonate block copolymers from comparative example 1 and from comparative example 2 were determined as described further above using AFM. It was found that in the polysiloxane-polycarbonate block copolymer from comparative example 1 the numerical proportion of polysiloxane domains larger than or equal to 12 nm and smaller than 200 nm, based on the total number of polysiloxane domains larger than or equal to 12 nm, is 96.8%. In the polysiloxane-polycarbonate block copolymer from comparative example 2 the numerical proportion of polysiloxane domains larger than or equal to 12 nm and smaller than 200 nm, based on the total number of polysiloxane domains larger than or equal to 12 nm, is 98.9%. Experience has shown that especially polysiloxane domains of 200 nm or more in size result in severe surface defects in injection-moulded components. Polysiloxane domains of 200 nm or more in size can also result in deterioration of the aesthetic appearance of injection-moulded components. The products from comparative examples 1 and 2 thus fail to meet the requirement of a high proportion of small polysiloxane domains.

The discs of the reactor have a surface area to which the reaction mixture is applied of 2 m². The application rate based on the surface area to which the reaction mixture is applied is 2.7 kg/m²h Comparative example 3: Experiment with twin-screw extruder.

With the experimental setup according to FIG. 2 1.2 kg/h of oligocarbonate (component A) were metered into the twin-screw extruder (1) via the gravimetric metered addition means (2). The speed of the extruder was set to 190 rpm. 0.060 kg/h of hydroxyaryl-terminated polysiloxane containing a compatibilizer (component B1), containing 1.2 ppm of Na based on the mass of the employed hydroxyaryl-terminated polysiloxane, corresponding to 5.22*10⁵ mol of Na per kg of the employed hydroxyaryl-terminated polysiloxane, was introduced into the barrel (d) of the twin-screw extruder (1) via the pump (4). A negative pressure of 40-50 mbara was applied to the barrel (e) and a negative pressure of 0.5 mbara was applied to each of the barrels (g), (i) and (j). The extruder barrels were heated according to the following scheme: Barrel (a) unheated, barrel (b) 170° C., barrels (c) and (d) 240° C., barrel (e) 250° C., barrel (f) 260° C., barrels (g) and (h) 270° C., barrel (i) 275° C., barrel (j) 285° C. and barrel (k) 295° C.

In the section of the extruder comprising the barrels (g) to (k), which is usable for the polycondensation, a surface area of 0.229 m² is available for application with the reaction mixture. This surface area is composed of the surface area of the two screw shafts and the barrel bores. The application rate, based on the surface area, to which the reaction mixture is applied, of the extruder was 5.5 kg/m²h.

The resulting polysiloxane-polycarbonate block copolymer has a bright colour and has an MVR of 5.8 cm³/10 min/eta rel 1.318.

### Comparative Example 4

Experiment with Twin-Screw Extruder.

With the experimental setup according to FIG. 2 2.0 kg/h of oligocarbonate (component A) were metered into the twin-screw extruder (1) via the gravimetric metered addition means (2). The speed of the twin-screw extruder (1) was set to 380 rpm. 0.10 kg/h of hydroxyaryl-terminated polysiloxane (component B1) containing 1.2 ppm of Na based on the mass of the employed hydroxyaryl-terminated polysiloxane, corresponding to 5.22*10⁵ mol of Na per kg of the employed hydroxyaryl-terminated polysiloxane, was introduced into the barrel (d) of the twin-screw extruder (1) via the pump (4). A negative pressure of 40-50 mbara was applied to the barrel (e) and a negative pressure of 0.5 mbara was applied to each of the barrels (g), (i) and (j). The extruder barrels were heated according to the following scheme: Barrel (a) unheated, barrel (b) 170° C., barrels (c) and (d) 240° C., barrel (e) 250° C., barrel (f) 260° C., barrels (g) and (h) 270° C., barrel (i) 275° C., barrel (j) 285° C. and barrel (k) 295° C.

The resulting polysiloxane-polycarbonate block copolymer was light in colour and had an eta rel of 1.270.

The surface area to which the reaction mixture is applied in the region of the extruder utilized for polycondensation is 0.229 m². The application rate, based on the surface area, to which the reaction mixture is applied, of the extruder was 9.2 kg/m²h.

In comparative examples 3 and 4, a twin-screw extruder was used for process step 2. Comparative example 3 was able to demonstrate that a high proportion of small polysiloxane domains is achievable. Comparative example 3 shows that the polysiloxane-polycarbonate block copolymer does not contain domains equal to or larger than 200 nm. However, the application rate based on the surface area to which the reaction mixture is applied is very low in comparative example 3. Since polycondensation processes with elimination of phenol generally scale with the surface area available for mass transfer to the gas phase this process cannot be transferred to an industrial scale where on a continuous basis from 100 kg to more than 500 kg/h of polysiloxane-polycarbonate block copolymer are to be produced on one production line.

To allow higher throughputs in comparative example 4 the screw speed was increased by more than a factor of 2 and the application rate based on the surface area to which the reaction mixture is applied was increased by about 80%. It is apparent from table 1 that the domains become larger. Domains >500 nm even occur. Viscosity also decreases. This means that for further increasing throughputs it is to be expected to result in a deterioration in product quality in terms of viscosity and polysiloxane domain size. While the application rate based on the surface area to which the reaction mixture is applied is higher than in comparative example 3, it is still unsatisfactory. Furthermore, the quality requirements are not met. In light of EP0726285 it is especially surprising here that when using extruders in the last process step scaleup to an industrial process is not possible/product quality is too poor at the throughputs necessary for an industrial process.

Comparative examples 3 and 4 thus show that the process using a twin-screw extruder is uneconomic. It has thus surprisingly been shown that the configuration of the process for a polysiloxane-polycarbonate block copolymer described in EP0726285 neither results in good product quality nor is economic.

### Comparative Example 5

Experiment with High-Viscosity Reactor.

Using the experimental setup according to FIG. 3, 28.6 kg/h of oligocarbonate (component A) and 1.43 kg/h of a hydroxyaryl-terminated polysiloxane containing a compatibilizer (component B1) and 1.2 ppm of Na, based on the mass of the employed hydroxyaryl-terminated polysiloxane, corresponding to 5.22*10 mol of Na per kg of the employed hydroxyaryl-terminated polysiloxane were metered into the twin-screw extruder (1). The speed of the twin-screw extruder (1) was 850 rpm. The extruder barrels were heated according to the following scheme: Barrel (a) unheated, barrel (b) 170° C., barrels (c) and (d) 240° C., barrel (e) 250° C., barrel (f) 260° C., barrels (g) and (h) 270° C., barrel (i) 275° C., barrel (j) 285° C. and barrel (k) 295° C. A pressure of 140 mbara was applied to the barrel (e) and a pressure of 0.8 mbara was applied to each of the barrels (g), (i) and (j). The outlet temperature from the twin-screw extruder (1) was 308° C. The extruded polymer melt was transferred to the high-viscosity reactor (2) via a pipe conduit. The speed of the high-viscosity reactor (2) was 30 rpm. The barrel temperature of the high-viscosity reactor (2) was 330° C. The pressure in the interior of the high-viscosity reactor (2) was 0.5 mbara. A light-coloured polysiloxane-polycarbonate block copolymer having a relative solution viscosity of 1.376 was obtained. The inner surface area, to which the reaction mixture is applied, of the reactor available for the polycondensation is 3 m². The application rate based on the inner surface area to which the reaction mixture is applied is 10 kg/m²h.

### Comparative Example 6

Experiment with High-Viscosity Reactor.

Using the experimental setup according to FIG. 3, 23.8 kg/h of oligocarbonate (component A) and 1.19 kg/h of hydroxyaryl-terminated polysiloxane (component B1) containing a compatibilizer and 1.2 ppm of Na, based on the mass of the employed hydroxyaryl-terminated polysiloxane, corresponding to 5.22*10⁻⁵ mol of Na per kg of the employed hydroxyaryl-terminated polysiloxane were metered into the twin-screw extruder (1). The speed of the extruder was 700 rpm. The extruder barrels of the twin-screw extruder (1) were heated according to the following scheme: Barrel (a) unheated, barrel (b) 170° C., barrels (c) and (d) 240° C., barrel (e) 250° C., barrel (f) 260° C., barrels (g) and (h) 270° C., barrel (i) 275° C., barrel (j) 285° C. and barrel (k) 295° C. Barrel (e) and each of barrels (g), (i) and (j) were at standard pressure. The melt was transferred to the high-viscosity reactor (2). The speed was 45 rpm. The barrel temperature of the high-viscosity reactor (2) was 310° C. The pressure applied at the barrel of the high-viscosity reactor (2) was less than 1.6 mbara. A light-coloured polysiloxane-polycarbonate block copolymer having a relative solution viscosity of 1.31 was obtained.

The application rate based on the surface area of the high-viscosity reactor to which the reaction mixture is applied was 8.25 kg/m²h.

Comparative examples 5 and 6 were performed with a high-viscosity reactor. Comparative example 5 did manage to achieve a high proportion of small polysiloxane domains but at the cost of an excessively high viscosity. As is apparent in table 1 the viscosity was able to be reduced but this markedly increased the proportion of large polysiloxane domains. This shows that this type of reactors are unsuitable for production of polysiloxane-polycarbonate block copolymers having the desired features. In addition, the application rate based on the surface area to which the reaction mixture is applied would necessitate the use of a very large reactor if the process according to this example were to be converted to an industrial scale where on a continuous basis from 100 kg to more than 500 kg/h of polysiloxane-polycarbonate block copolymer are to be produced on one production line. The process is therefore uneconomic.

### Example 7 (Inventive)

### With Precisely One Thin-Film Evaporator According to FIG. 4.

In the experimental setup according to FIG. 2 initially 21 kg/h of an oligocarbonate (component A) having a relative viscosity of 1.17 were metered into the barrel (a) of the twin-screw extruder (1) and the hydroxyaryl-terminated polysiloxane (component B1) containing a compatibilizer and 1.2 ppm of Na, based on the mass of the employed hydroxyaryl-terminated polysiloxane, corresponding to 5.22*10⁻⁵ mol of Na per kg of the employed hydroxyaryl-terminated polysiloxane, was introduced into the barrel (d) of the twin-screw extruder (1) at 1.05 kg/h. The twin-screw extruder (1) was operated at a speed of 500 rpm. The extruder barrels of the twin-screw extruder (1) were heated according to the following scheme: Barrel (a) unheated, barrel (b) 170° C., barrels (c) and (d) 240° C., barrel (e) 250° C., barrels (f) to (k) 260° C. No negative pressure is applied. Since the lack of negative pressure means that any reaction products formed, such as for example phenol, are discharged only to a very small extent, if at all, it is essentially a physical mixture (blend) of an oligocarbonate and a polysiloxane without a reactive bond that is formed.

The blend of an oligocarbonate and a polysiloxane formed in this way is melted in a plasticizing extruder (1) and conveyed to a thin-film evaporator (2) according to FIG. 4 using a gear pump (not shown). The blend is introduced into the thin-film evaporator (2) at a melt temperature of about 265° C. and an application rate of 20 kg/h and condensed at a barrel temperature of 334° C. The pressure in the thin-film evaporator (2) was 0.4 mbara. A light-coloured pellet material having a relative solution viscosity of 1.30 was obtained.

The thin-film evaporator (2) had an inner surface area to which reaction mixture is applied of 0.5 m². The inner surface area of the thin-film evaporator (2) to which reaction mixture is applied was wiped over at a speed of 500 rpm by a vertical rotor having four wiper blade elements at the circumference.

The application rate based on the inner surface area of the reaction chamber of the thin-film evaporator to which reaction mixture is applied was 40 kg/m²h.

### Example 8 (Inventive)

with precisely one thin-film evaporator according to FIG. 4.

Just as described in example 7 initially a blend of an oligocarbonate (component A) and a hydroxyaryl-terminated polysiloxane containing a compatibilizer (component B1) and 1.2 ppm of Na, based on the mass of the employed hydroxyaryl-terminated polysiloxane, corresponding to 5.22*10⁻⁵ mol of Na per kg of the employed hydroxyaryl-terminated polysiloxane, were produced. This is melted in a plasticizing extruder (1) and conveyed using a gear pump (not shown) to a thin-film evaporator (2) according to FIG. 4. The blend is supplied to the thin-film evaporator (2) at a throughput of 18 kg/h and a melt temperature of about 265° C. and condensed at a barrel temperature of 334° C. The pressure in the thin-film evaporator (2) was 0.4 mbar. The thin-film evaporator (2) had an inner surface area of the reaction chamber to which reaction mixture is applied of 0.5 m². The inner surface area of the reaction chamber of the thin-film evaporator (2) to which reaction mixture is applied was wiped over at a speed of 450 rpm by a vertical rotor having four wiper blade elements at the circumference.

A light-coloured pellet material having a relative solution viscosity of 1.285 was obtained.

The application rate based on the inner surface area of the reaction chamber of the thin-film evaporator to which reaction mixture is applied was 36 kg/m²h.

The two inventive examples 7 and 8 show that a special condensation reactor having a high application rate based on the inner surface area to which the reaction mixture is applied while observing the process parameters according to the invention makes it possible to produce block copolymers having a solution viscosity in the inventive range. Said copolymers simultaneously have a high proportion of small polysiloxane domains.

The application rate which is markedly higher compared to the comparative examples and based on the inner surface area of the reaction chamber to which reaction mixture is applied shows that it is possible to realize a process on the industrial scale with lower reaction chamber inner surface areas and is thus more economic.

### Example 9 (Inventive)

### With Precisely Two Thin-Film Evaporators According to FIG. 1.

36.9 kg/h of oligocarbonate (component A) were plasticized in a plasticizing extruder (1) and 2 kg/h of hydroxyaryl-terminated polysiloxane (component B2) without compatibilizer but with 0.9 ppm of Na, based on the mass of the employed hydroxyaryl-terminated polysiloxane, corresponding to 3.92*10⁻⁵ mol of Na per kg of the employed reaction mixture, were incorporated into the melt in the plasticizing extruder (1) to produce a premixture. For further homogenization the premixture of oligocarbonate and hydroxyaryl-terminated polysiloxane was passed through a DLM/S 007 dynamic mixer (5) from INDAG Maschinenbau which was operated at a speed of 500 rpm. At a temperature of 284° C. the premixture subsequently entered a first thin-film evaporator (2) which has an inner surface area of the reaction chamber to which reaction mixture is applied of 0.5 m² and was operated at a barrel temperature of 310° C. in its upper half and of 300° C. in its lower half and a pressure of 1 mbara. The obtained melt was discharged and using a gear pump (3) conveyed to the second thin-film evaporator (2′) having an inner surface area of the reaction chamber to which reaction mixture is applied of 0.5 m².

The second thin-film evaporator (2′) was operated at a pressure of 1 mbara. The upper half of the reaction chamber of the thin-film evaporator (2′) was heated to 320° C. and the lower half to 317° C. The melt was thus further condensed and was discharged via the gear pump (3′) at 361° C. The inner surface area of the reaction chamber of the thin-film evaporator (2) to which reaction mixture is applied was wiped over at a speed of 330 rpm by a vertical rotor having four wiper blade elements at the circumference. The inner surface area of the reaction chamber of the thin-film evaporator (2′) to which reaction mixture is applied was wiped over at a speed of 220 rpm by a vertical rotor having four wiper blade elements at the circumference.

The application rate based on the total inner surface area of the reaction chamber of both thin-film evaporators to which reaction mixture is applied was 38.9 kg/m²h.

A bright polysiloxane-polycarbonate block copolymer having a relative solution viscosity of 1.324 was obtained.

### Example 10 (Inventive)

### With Precisely Two Thin-Film Evaporators According to FIG. 1.

41 kg/h of oligocarbonate (component A) were plasticized in a plasticizing extruder (1) and 2.32 kg/h of hydroxyaryl-terminated polysiloxane without compatibilizer (component B2) with an addition of 0.9 ppm of Na, based on the mass of the employed hydroxyaryl-terminated polysiloxane, corresponding to 3.92*10 ⁵ mol of Na per kg of the employed reaction mixture, and with an OH number of 19.2 mg KOH/g were incorporated into the melt in the plasticizing extruder (1) to produce a premixture. For further homogenization the premixture of oligocarbonate and hydroxyaryl-terminated polysiloxane without compatibilizer was passed through a DLM/S 007 dynamic mixer (5) from INDAG Maschinenbau which was operated at a speed of 500 rpm. At a temperature of 275° C. the premixture subsequently entered a first thin-film evaporator (2) which has an inner surface area of the reaction chamber to which reaction mixture is applied of 0.5 m² and which was operated at a barrel temperature of uniformly 290° C. and a pressure of 1 mbara. The obtained melt was discharged and using a gear pump (3) conveyed to the second thin-film evaporator (2′) having an inner surface area of the reaction chamber to which reaction mixture is applied of 0.5 m².

The second thin-film evaporator (2′) was operated at a pressure of 1 mbara. The second thin-film evaporator (2′) was heated uniformly to 310° C. The melt was thus further condensed and discharged via the gear pump (3′) at 325° C. The inner surface area of the reaction chamber of the thin-film evaporator (2) to which reaction mixture is applied was wiped over at a speed of 189 rpm by a vertical rotor having four wiper blade elements at the circumference. The inner surface area of the reaction chamber of the thin-film evaporator (2′) to which reaction mixture is applied was wiped over at a speed of 202 rpm by a vertical rotor having four wiper blade elements at the circumference.

A bright polysiloxane-polycarbonate block copolymer having a relative solution viscosity of 1.315 was obtained.

The application rate based on the total inner surface area of the reaction chamber of both thin-film evaporators to which reaction mixture is applied was 43.3 kg/m²h.

Inventive experiments 9 and 10 demonstrate that the object is also achieved with 2 serially arranged special condensation reactors having a high application rate based on the inner surface areas of the reaction chambers to which reaction mixture is applied. The advantageous combination of desired solution viscosity and high proportion of small polysiloxane domains is also achieved here. The co-catalyst dosage was moreover able to be reduced by 25% compared to the other examples. When using two serially arranged special condensation reactors it was also possible to eschew a compatibilizer without this resulting in the loss of the advantageous combination of desired solution viscosity and high proportion of small polysiloxane domains.

TABLE 1

| | | | | | Numerical | |
|---|---|---|---|---|---|---|
| | | | | Numerical | proportion of | |
| | | | | proportion of | polysiloxane | |
| | | | | polysiloxane | domains ≥200 nm | Relative |
| | | | | domains ≥12 nm | [%] | solution |
| | | Reactor in last | Co-catalyst | and <200 nm | Difference | viscosity |
| No. | | reaction stage | [ppm Na] | [%] | to 100% | (eta rel.) |
| 1 | Comparative | Rotating-disc | 1.2 | 96.8 | 3.2 | 1.26 |
| | example | reactor | | | | |
| 2 | Comparative | Rotating-disc | 1.2 | 98.9 | 1.1 | 1.33 |
| | example | reactor | | | | |
| 3 | Comparative | Twin-screw | 1.2 | 100 | 0 | 1.318 |
| | example | extruder | | | | |
| 4 | Comparative | Twin-screw | 1.2 | 99.8 | 0.2 | 1.270 |
| | example | extruder | | | | |
| 5 | Comparative | High-viscosity | 1.2 | 100 | 0 | 1.376 |
| | example | reactor | | | | |
| 6 | Comparative | High-viscosity | 1.2 | 98.3 | 1.7 | 1.31 |
| | example | reactor | | | | |
| 7 | Inventive | 1 TFE | 1.2 | 100 | 0 | 1.30 |
| 8 | Inventive | 1 TFE | 1.2 | 99.7 | 0.3 | 1.285 |
| 9 | Inventive | 2 TFE in series | 0.9 | 100 | 0 | 1.324 |
| 10 | Inventive | 2 TFE in series | 0.9 | 100 | 0 | 1.315 |

1. A process for continuous production of a polysiloxane-polycarbonate block copolymer using precisely one special condensation reactor,
wherein the process comprises the following process steps:
(1) providing an oligocarbonate having a relative solution viscosity of 1.08 to 1.22 and having an OH group content of 1000 to 2500 ppm,
(2) mixing the oligocarbonate from step (1) with a hydroxyaryl-terminated polysiloxane to provide a reaction mixture containing an oligocarbonate and a hydroxyaryl-terminated polysiloxane,
(3) introducing the reaction mixture provided in step (2) containing an oligocarbonate and a hydroxylaryl-terminated polysiloxane into the precisely one special condensation reactor, wherein the special condensation reactor comprises a reaction chamber having a shaft with at least one spreader at the circumference, wherein the spreader has an outer edge, and wherein the outer edge of the at least one spreader rotates at a defined distance from outer wall of the reaction chamber,
(4) reacting the reaction mixture from step (3) to afford a polysiloxane-polycarbonate block copolymer, wherein the reaction mixture is conveyed from an inlet of the special condensation reactor to an outlet of the special condensation reactor,
(5) discharging the polysiloxane-polycarbonate block copolymer obtained from step (4) from the special condensation reactor,
wherein in step (4) in the precisely one special condensation reactor the following process conditions are observed:
(4.a) pressure in the reaction chamber of 0.01 mbara to 10 mbara,
(4.b) temperature of the reaction mixture in the reaction chamber of 280° C. to 380° C.,
(4.c) circumferential velocity of the at least one spreader at the circumference of the axially extending rotationally symmetrical reaction chamber inner surface area of the reactor of 1 to 5 m/s,
wherein the application rate of reaction mixture to the reaction chamber is from 20 kg/m²h to 100 kg/m²h,
and
wherein before the introducing according to step (3) of the reaction mixture containing oligocarbonate and hydroxyaryl-terminated polysiloxane provided in step (2) this reaction mixture is admixed with an amount, based on the mass of the hydroxyaryl-terminated polysiloxane, of 5*10−7 mol to 1*10−3 mol of co-catalyst per kg of hydroxyaryl-terminated polysiloxane,
wherein this co-catalyst is selected from one or more co-catalysts based on alkali metals and/or alkaline earth metals.

2. A process for continuous production of a polysiloxane-polycarbonate block copolymer using a number of serially arranged special condensation reactors,
wherein the process comprises the following process steps:
(1) providing an oligocarbonate having a relative solution viscosity of 1.08 to 1.22 and having an OH group content of 1000 to 2500 ppm,
(2) mixing the oligocarbonate from step (1) with a hydroxyaryl-terminated polysiloxane to provide a reaction mixture containing an oligocarbonate and a hydroxyaryl-terminated polysiloxane,
(3) introducing the reaction mixture provided in step (2) containing an oligocarbonate and a hydroxylaryl-terminated polysiloxane into a first of a number of serially arranged special condensation reactors, wherein each of the number of serially arranged special condensation reactors comprises a reaction chamber having a shaft with at least one spreader at the circumference, wherein the spreader has an outer edge, and wherein the outer edge of the at least one spreader rotates at a defined distance from an outer wall of the reaction chamber,
(4) reacting the reaction mixture from step (3) to afford a polysiloxane-polycarbonate block copolymer, wherein the reaction mixture is conveyed from an inlet of the first special condensation reactor to an outlet of the last special condensation reactor of the number of serially arranged special condensation reactors,
(5) discharging the polysiloxane-polycarbonate block copolymer obtained from step (4) from the last special condensation reactor,
wherein in step (4) in the last of the number of serially arranged special condensation reactors the following process conditions are observed:
(4.a) pressure in the reaction chamber of 0.01 mbara to 10 mbara,
(4.b) temperature of the reaction mixture in the reaction chamber of 280° C. to 380° C.,
(4.c) circumferential velocity of the at least one spreader at the circumference of the axially extending rotationally symmetrical reaction chamber inner surface area of the reactor of 1 to 5 m/s,
wherein the application rate of reaction mixture to the reaction chambers is from 20 kg/m²h to 100 kg/m²h,
and
wherein before the introducing according to step (3) of the reaction mixture containing oligocarbonate and hydroxyaryl-terminated polysiloxane provided in step (2) this reaction mixture is admixed with an amount, based on the mass of the hydroxyaryl-terminated polysiloxane, of 5*10−7 mol to 1*10−3 mol of co-catalyst per kg of hydroxyaryl-terminated polysiloxane,
wherein this co-catalyst is selected from one or more co-catalysts based on alkali metals and/or alkaline earth metals.

3. The process according to claim 1, wherein the co-catalyst is added to the hydroxyaryl-terminated polysiloxane in the specified amount already before step (2).

4. The process according to claim 1, wherein in process step (4) in the single special condensation reactor the following process condition is observed:
(4.a) that the pressure in the reaction chamber of the special reaction reactor is from 0.1 mbara to 6 mbara.

5. The process according to claim 1, wherein the relative solution viscosity of the oligocarbonate provided in step (1) is from 1.11 to 1.22.

6. The process according to claim 1, wherein the polysiloxane content of the polysiloxane-polycarbonate block copolymer is from 2% to 15% by weight, wherein the polysiloxane content is based on the total weight of the polysiloxane-polycarbonate block copolymer.

7. The process according to claim 6, wherein the polysiloxane content of the polysiloxane-polycarbonate block copolymer is from 3% to 10% by weight, wherein the polysiloxane content is based on the total weight of the polysiloxane-polycarbonate block copolymer.

8. The process according to claim 6, wherein the polysiloxane content of the polysiloxane-polycarbonate block copolymer is from 4% to 8% by weight, wherein the polysiloxane content is based on the total weight of the polysiloxane-polycarbonate block copolymer.

9. The process according to claim 6, wherein the polysiloxane content of the polysiloxane-polycarbonate block copolymer is from 4.5% to 5.5% by weight, wherein the polysiloxane content is based on the total weight of the polysiloxane-polycarbonate block copolymer.

10. The process according to claim 1, wherein the OH group content of the oligocarbonate provided in step (1) is from 1200 to 2300 ppm.

11. The process according to claim 1, wherein in step (1) the reaction mixture containing an oligocarbonate having a relative solution viscosity of 1.08 to 1.22, and having an OH group content of 1000 to 2500 ppm, and containing a hydroxyaryl-terminated polysiloxane is produced using dynamic and/or static mixers.

12. The process according to claim 2, wherein in step (4) of the process the following process conditions are observed:
in the first special condensation reactor:
(4.1.a) pressure in the reaction chamber of 1 mbara to 10 mbara,
(4.1.b) temperature of the reaction mixture in the reaction chamber of 270° C. to 350° C.,
(4.1.c) frequency of surface renewal of the reaction mixture of 10 to 30 Hz,
and in the last special condensation reactor:
(4.2.a) pressure in the reaction chamber of 0.1 mbara to 3 mbara,
(4.2.b) temperature of the reaction mixture in the reaction chamber of 280° C. to 370° C.,
(4.2.c) frequency of surface renewal of the reaction mixture of 10 to 30 Hz,
wherein the application rate of reaction mixture to the reaction chambers is from 30 kg/m²h to 60 kg/m²h.

13. A polysiloxane polycarbonate block copolymer comprising the following features:
the polysiloxane content is from 2% to 15% by weight based on the total weight of the polysiloxane-polycarbonate block copolymer,
the numerical proportion of polysiloxane domains larger than or equal to 12 nm and smaller than 200 nm is more than 90.0%, in each case based on the total number of polysiloxane domains larger than or equal to 12 nm,
a relative solution viscosity of to 1.24 to 1.34.

14. A polysiloxane polycarbonate block copolymer comprising the following features:
the polysiloxane content is from 3% to 10% by weight based on the total weight of the polysiloxane-polycarbonate block copolymer,
the numerical proportion of polysiloxane domains larger than or equal to 12 nm and smaller than 200 nm is more than 99.0%, in each case based on the total number of polysiloxane domains larger than or equal to 12 nm,
a relative solution viscosity of 1.24 to 1.34.

15. A method for producing shaped bodies comprising providing a polysiloxane-polycarbonate block copolymer according to claim 13.

16. The process according to claim 2, wherein in process step (4) in the last special condensation reactor of a number of serially arranged special condensation reactors the following process condition is observed:
(4.a) that the pressure in the reaction chamber of the special reaction reactor is from 0.1 mbara to 6 mbara.
